(19) United States
(12) Patent Application Publication
(10) Pub. No.: US 2025/0067366 A1
(43) Pub. Date: Feb. 27, 2025

(54) METHOD AND APPARATUS FOR CATCHING SILT

(71) Applicants: David Hart, Uniontown, OH (US); Michael Thompson, Las Vegas, NV (US); Timothy Pierzynski, Apple Creek, OH (US)

(72) Inventors: David Hart, Uniontown, OH (US); Michael Thompson, Las Vegas, NV (US); Timothy Pierzynski, Apple Creek, OH (US)

(21) Appl. No.: 18/946,219

(22) Filed: Nov. 13, 2024

Related U.S. Application Data
(63) Continuation-in-part of application No. 16/733,775, filed on Jan. 3, 2020, now Pat. No. 12,168,189.
(60) Provisional application No. 62/917,845, filed on Jan. 4, 2019.

(51) Int. Cl. F16K 51/00; F16K 27/12

(52) U.S. Cl. CPC F16K 51/00; F16K 27/12

(57) ABSTRACT

A silt and debris catching apparatus comprises a housing component and a catchment component. The housing component is adapted to fit within a valve box assembly at a depth below a freeze line. The housing component has a field-installable second handle. The catchment component is coupled to the housing component and includes a filter. The filter retains material that enters the valve box assembly.

### CROSS REFERENCE TO RELATED APPLICATIONS

This application claims the benefit and is a Continuation-In-Part application of U.S. patent application Ser. No. 16/733,775, filed on Jan. 3, 2020; which claims priority to U.S. Provisional Patent Application Ser. No. 62/917,845, filed on Jan. 4, 2019; and of which the entirety of which disclosures are incorporated herein by reference.

### TECHNICAL FIELD

The following generally relates to pipe systems. More specifically, the following relates to valve box assemblies of underground pipe systems. Still more specifically, the following relates to an apparatus that provides access protection by at least preventing materials from covering a valve located within valve box assemblies without intrusion into or changing the design of valves associated with valve box assemblies.

### BACKGROUND

Miles of distribution pipes may carry water and gas from an origination location to several different destinations. Typically, control valves are placed at different intervals along the pipes and below the surface to control the flow of water or gas within the pipes. The surface under which this network runs may be fairly even (in a use case of streets) or may be varied (as in a use case through fields and other natural terrain). In the event of pipe breakage or normal pipe maintenance, it is often necessary to access the control valves to prevent the flow of water or gas into certain sections of pipe. These valves are placed in valve box assemblies that may include one or more valve body risers. The valve body risers are often tubular castings that extend from a ground surface (such as for example, a sidewalk, a street or a portion of ground) downwards to a pipe or pipe system or network. Valve box assemblies typically include a surface opening for access to the valve. The surface opening of a valve box is typically covered with a loosely fitted cover. When it is necessary to access and turn on or off a control valve, the cover may be removed and a valve wrench is inserted into the valve box. The valve wrench couples to the control valve and a user rotates the valve wrench thereby opening or closing the control valve. Access typically occurs for routine maintenance as well as for emergencies (such as pipe system malfunctions including line breaks).

Over time and especially in remote installations, the loosely fitted cover may become hidden by soil or debris, as well as soil or debris may obscure the control valve within the one or more valve body risers thereby creating difficulties in locating and operating the control valve. The loosely fitting cover may not be visible and/or the control valve within the valve body risers may be covered with soil or debris, requiring extra time, effort and tools to effect operation of the control valve. Special tools may be required to remove silt and debris from with one or more valve box assemblies. This process is time consuming and manually difficult. Thus, in emergency situations, such as for example if a pipe breaks, a delay in finding and/or obtaining access to the control valve may prove to be costly as water or gas may be unnecessarily wasted. In the case of pipe breakage, accessing the control valve may be critical and delays caused by inaccessible valves may drastically increase problems associated with fixing a pipe break. Further, systems that may filter debris that are located near a ground level are susceptible to freeze conditions (or thaw and freeze conditions) which may eliminate or retard desired functions. In other words, near-surface filtration systems are susceptible to natural conditions that may result in disastrous consequences.

Information related to control (for example, when the valve box assembly was last inspected or what pipes are in communication with a certain control valve) both for emergencies and for routine maintenance may be difficult to locate in some circumstances. In other circumstances, such as a road is being repaved in which loosely fitting covers are typically removed while the existing asphalt is removed, the pipe systems with control valves located under road surfaces may during this process, have substantial (and heavy) debris entering the valve box assembly thus covering control valves. This often may lead to extra work as well as possibly unnecessarily extra inspections of or in shutting off of valves—at times with unknown effects for the affected pipe systems and most any services downstream from the shutoff.

### SUMMARY

In exemplary embodiments disclosed herein, an apparatus is provided for maintaining valve accessibility in a valve box assembly. The apparatus has a housing component configured to pass through a first valve body riser and rest on an annular portion of a second valve body riser of the valve box assembly. The apparatus also has a catchment component comprising a top portion and a mesh portion. The mesh portion is adapted to retain material that enters the valve box assembly. Further, the top portion of catchment component is adapted to attach to the housing component; as the housing component is configured to slidably receive the top portion of the catchment component.

The embodiment may also have a housing component that is configured with a first handle defining a pair of slots spaced apart from one another. It is to be appreciated that the apparatus self-aligns as the apparatus passes through the first valve body riser. Upon being installed, the housing component is guided by a set of threads of the first valve body riser as the housing component passes through the first valve body riser to rest on the annular portion of the second valve body riser of the valve box assembly.

Embodiments of the disclosed innovation also include a method for configuring an apparatus for maintaining valve accessibility in a valve box assembly. The method includes locating a valve box assembly that has a first valve body riser, a second valve body riser and a valve box cover. After removing the valve box cover, the method includes placing a top portion of a catchment component of an apparatus into a slidably receiving portion of a housing component that is configured to provide a path through rigid members. The method includes dropping the apparatus into the valve box assembly and reengaging the valve box cover with the first valve body riser.

It is to be appreciated that embodiments of the method include a housing component that is configured with a first handle defining a pair of slots spaced apart from one another; and a catchment component that is configured to self-align as the apparatus passes through the first valve body riser. Other embodiments may include that during the dropping, the housing component may be guided by a set of threads of the first valve body riser as the housing component passes through the first valve body riser to rest on an annular portion of the second valve body riser of the valve box assembly.

In exemplary embodiments disclosed herein, an apparatus is provided for maintaining valve accessibility in a valve box assembly. The apparatus has a housing component that is configured to pass through a first valve body riser and rest on an annular portion of a second valve body riser of a valve box assembly. The housing component is also configured to have a first handle. The apparatus also has a catchment component that has a top portion and a mesh portion. The mesh portion is adapted to retain material that enters the valve box assembly. Further, the catchment component self-aligns as the apparatus passes through the first valve body riser and the housing component is guided by a set of threads of the first valve body riser.

In other embodiments, an apparatus may also have a field-installable adjustable second handle that is configured to attach to the housing component. It is to be appreciated that a housing component of the apparatus rests below a freeze line of the valve box assembly. For embodiments of the installed apparatus, a field-installable adjustable second handle of the housing component comprises a portion that rests at or near a valve box cover of the valve box assembly. A housing component can be configured to have an outer wall with a diameter less than an inner diameter of the set of threads of the first valve body riser and greater than an inner diameter of the second valve body riser. Further, a housing component can be configured to provide a path through rigid members to slidably receive the top portion of the catchment component, while the top portion of the catchment component is configured to be flexible and compresses while passing through the rigid members and rebounds to the top portion prior size after passing through.

Embodiments of the disclosed innovation also include a method for configuring an apparatus for maintaining valve accessibility in a valve box assembly. The method includes locating a valve box assembly that has a first valve body riser, a second valve body riser and a valve box cover. After removing the valve box cover, the method includes placing a top portion of a catchment component of an apparatus into a slidably receiving portion of the housing component that is configured to provide a path through rigid members. In embodiments, the housing component has a first handle.

In embodiments, a step includes dropping the apparatus into the valve box assembly. It is to be appreciated that the catchment component is configured to self-align with the dropping the apparatus into the valve box assembly as the apparatus passes through the first valve body riser and a housing component is guided by a set of threads of the first valve body riser. Finally, the method includes reengaging the valve box cover. It is to be further appreciated that the dropping comprises a housing component of the apparatus resting on an annular portion of the second valve body riser and that the depth of the housing component resting on the annular portion is below a freeze line for the valve box assembly.

Other embodiments include a step of attaching a field-installable adjustable second handle to the housing component prior to dropping the apparatus into the valve box assembly. The attaching of the field-installable adjustable second handle includes selecting an amount of the field installable second handle and inserting the field installable second handle into the housing component to obtain a depth of a top loop of the field installable second handle at or near a valve box cover of the valve box assembly with the housing component resting on the annular portion.

Exemplary embodiments disclosed include the above methods with the top portion of the catchment component being configured to be flexible and compressing while passing through the rigid members and rebounding to the flexible top portion prior size after passing through.

Still other exemplary embodiments include a system for maintaining valve accessibility in a valve box assembly. The system includes a valve box assembly that comprises a first valve box riser, a second valve box riser and a valve box cover; a housing component of an apparatus that is configured to pass through the first valve body riser and rest on an annular portion of the second valve body riser (in some embodiments, the housing component configured to have a first handle integrally formed from a single piece of rigid polymer with a body of the housing component); a catchment component that has a top portion and a mesh portion (the mesh portion, adapted to retain material that enters the valve box assembly); and a field-installable adjustable second handle that is configured to attach to the housing component.

During an installation, the catchment component self-aligns as the apparatus passes through the first valve body riser and the housing component is guided by a set of threads of the first valve body riser. A top portion of the housing component is configured to provide a path through rigid members to slidably receive the top portion of the catchment portion and the mesh portion of the catchment component is configured to be flexible and compresses while passing through the rigid members and rebounds to the flexible top portion prior size after passing through. It is to be appreciated that for an installed apparatus, the housing component rests below a freeze line of the valve box assembly and the field-installable adjustable second handle of the housing component comprises a portion that rests at or near a valve box cover of the valve box assembly.

In one aspect, an exemplary embodiment of the present disclosure may provide a silt and debris catching apparatus comprising: a housing component adapted to fit within a valve box assembly; and a catchment component comprising a filter, wherein the catchment component is coupled to the housing component and wherein the filter is adapted to retain material that enters the valve box assembly.

In another aspect, an exemplary embodiment of the present disclosure may provide a method for catching material that enters a valve box assembly comprising: placing a material catching apparatus within the valve box assembly; and selectively retaining material that enters the valve box assembly with the material catching apparatus.

In another aspect, an exemplary embodiment of the present disclosure may provide a method for locating a valve box assembly comprising: locating a radio-frequency identification whip within the valve box assembly.

Currently, it may be difficult to find a valve box assembly that is below the surface and covered with debris. At times, it may be crucial to quickly find a valve box assembly. Furthermore, information relating to the valve box assembly to the valve box may not be readily available. Thus, there is a continuous need for a system that aids in quickly locating a valve box assembly and determines information relating to a valve box assembly.

In one aspect, an exemplary embodiment of the present disclosure may provide a valve box assembly. The valve box assembly may include a pipe within the valve box assembly. The valve box assembly may further include a valve coupled to the pipe. The valve box assembly may further include a radio-frequency identification tag within the valve box assembly. This exemplary embodiment or another exemplary embodiment may provide a silt and debris catching apparatus within the valve box assembly, wherein the silt and debris catching apparatus includes a housing component and a filtration component adapted to retain material that enters the valve box assembly, and wherein the radio-frequency identification tag is within the housing component. This exemplary embodiment or another exemplary embodiment may provide wherein the silt and debris catching apparatus includes a handle with a channel and wherein the radio-frequency identification tag is within the channel. This exemplary embodiment or another exemplary embodiment may provide wherein the silt and debris catching apparatus includes a removable cover that covers the channel. This exemplary embodiment or another exemplary embodiment may provide wherein the silt and debris catching apparatus includes a first end and a second end below the first end and wherein the cover defines the first end.

This exemplary embodiment or another exemplary embodiment may provide wherein the radio-frequency identification tag includes first data associated with the silt and debris catching apparatus or the valve box assembly. This exemplary embodiment or another exemplary embodiment may provide wherein the first data includes a serial number that identifies the silt and debris catching apparatus or the valve box assembly. This exemplary embodiment or another exemplary embodiment may provide wherein the radio-frequency identification tag includes a read-only memory that stores the first data. This exemplary embodiment or another exemplary embodiment may provide wherein the serial number provides access to a database that includes second data associated with the silt and debris catching apparatus. This exemplary embodiment or another exemplary embodiment may provide wherein the second data includes at least one of: a geographic location of the silt and debris catching apparatus or the valve box assembly, a pipe diagram, a type of fluid that flows through the valve within the valve box assembly, what the valve within the valve box assembly effects, a date and a time that the valve box assembly was accessed, a date and a time that the silt and debris catching apparatus was inspected, a date and a time that the silt and debris catching apparatus was emptied, a status of the valve within the valve box assembly, and a fluid flow state.

This exemplary embodiment or another exemplary embodiment may provide wherein the radio-frequency identification tag includes a read/write memory that stores the first data associated with the silt and debris catching apparatus or the valve box assembly. This exemplary embodiment or another exemplary embodiment may provide wherein the first data includes editable data associated with the silt and debris catching apparatus or the valve box assembly. This exemplary embodiment or another exemplary embodiment may provide wherein the first data includes at least one of: a date and a time that the valve box assembly was accessed, a date and a time that the silt and debris catching apparatus was inspected, a date and a time that the silt and debris catching apparatus was emptied, and a status of the valve within the valve box assembly. This exemplary embodiment or another exemplary embodiment may provide wherein the serial number provides access to a database that includes second data associated with the silt and debris catching apparatus. This exemplary embodiment or another exemplary embodiment may provide wherein the radio-frequency identification tag is one of an active radio-frequency identification tag or a passive radio-frequency identification tag.

In another aspect, an exemplary embodiment of the present disclosure may provide a pipe system. The pipe system may include a first valve box assembly. The pipe system may further include a first radio-frequency identification tag within the first valve box assembly. The pipe system may further include a radio-frequency identification tag reader adapted to emit an electromagnetic signal and further adapted to receive first data from the first radio-frequency identification tag in response to the electromagnetic signal. The pipe system may further include a computing device adapted to read or edit the first data. This exemplary embodiment or another exemplary embodiment may provide a second valve box assembly; and a second radio-frequency identification tag, wherein the radio-frequency identification tag reader is further adapted to receive second data from the second radio-frequency identification tag in response to the electromagnetic signal, and wherein the computing device is further adapted to read or edit the second data. This exemplary embodiment or another exemplary embodiment may provide wherein the radio-frequency identification tag reader includes the computing device.

In yet another aspect, an exemplary embodiment of the present disclosure may provide a method for locating a valve box assembly. The method may include emitting a first electromagnetic signal from a radio-frequency identification tag reader. The method may further include receiving, with the identification tag reader, a first response to the first electromagnetic signal from a radio-frequency identification tag within a valve box assembly. The method may further include locating the valve box assembly based on the first response. This exemplary embodiment or another exemplary embodiment may provide wherein the first response includes a geographic location of the valve box assembly or a silt and debris catching apparatus within the valve box assembly. This exemplary embodiment or another exemplary embodiment may provide wherein the radio-frequency identification reader is stationary. This exemplary embodiment or another exemplary embodiment may provide moving to a first location, receiving the first response at the first location with the radio-frequency identification tag reader; reducing a reading range of the radio-frequency identification reader; emitting a second electromagnetic signal form the radio-frequency identification reader; moving to a second location; receiving a second response at the second location with the radio-frequency identification tag reader; and locating the valve box assembly based on the second response.

### BRIEF DESCRIPTION OF THE SEVERAL VIEWS OF THE DRAWINGS

Sample embodiments of the disclosure are set forth in the following description, are shown in the drawings and are particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is an operational partial cutaway perspective view depicting an embodiment of a valve box assembly with a silt and debris catching apparatus.

FIG. 2 is an assembled perspective view of a silt and debris catching apparatus in accordance with an exemplary embodiment of the present disclosure.

FIG. 3 is an exploded perspective view of the silt and debris catching apparatus depicted in FIG. 2.

FIG. 3A is an enlarged perspective view of a portion of the silt and debris catching apparatus depicted in FIG. 3.

FIG. 4 is a schematic diagram of a radio-frequency identification tag, a radio-frequency identification tag reader, a computing device, and a database in accordance with aspects of an embodiment of the innovation.

FIG. 5 is a longitudinal cross section isometric view of the operational embodiment depicted in FIG. 1 taken along the line 5-5 in FIG. 1.

FIG. 6 is a longitudinal partial cross-section perspective view of the operational embodiment depicted in FIG. 1 taken along line 5-5 in FIG. 1.

FIG. 7A is an assembled operational partial cutaway perspective view depicting an embodiment of a valve box assembly with a silt and debris catching apparatus.

FIG. 7B is a detail view of FIG. 7A indicating an aspect of the innovation.

FIG. 8 provides a top plan view of an embodiment of a housing component according to aspects of the innovation.

FIG. 9 provides a slightly angled from top perspective view of an embodiment of a housing component according to aspects of the innovation.

FIG. 10 provides side plan view of the embodiment of FIG. 8.

FIG. 11 provides a bottom plan view of an assembly of the embodiment of FIG. 8 with additional aspects of the innovation.

FIG. 12 provides a partial assembled section view of the embodiment shown in FIG. 11 taken along line 12-12 in FIG. 11 with an aspect of the innovation of a field installable second handle.

FIG. 13 is an assembled operational partial cutaway perspective view depicting an embodiment of a valve box assembly with a silt and debris catching apparatus.

Similar numbers refer to similar parts throughout the drawings.

### DETAILED DESCRIPTION

Initially, it is noted that the present disclosure is a continuation-in-part application of U.S. patent application Ser. No. 16/733,775, (the '775 Disclosure) filed on Jan. 3, 2020, the entirety of which is incorporated herein as if fully rewritten. Since this is a continuation-in-part of the '775 disclosure, some similar nomenclature may be used in descriptions of certain embodiments and there may be some instances in which nomenclature may differ. It is to be appreciated that clarity is provided by the context in which the nomenclature appears.

It is to be appreciated that another advantage of the disclosed innovation is that in other circumstances, such as a road is being repaved in which loosely fitting covers are typically removed while the existing asphalt is scraped, pipe systems with control valves located under the road surfaces may have substantial (and heavy) debris entering the valve box assembly thus covering control valves. Averting traditional issues such as extra work as well as possibly unnecessarily extra inspections of or in shutting off of valves—at times with unknown effects for the affected pipe systems and most any services downstream from the shutoff may come from the ability to deter this as well as recognize information related to the disclosure herein.

It is to be further appreciated that advantages of the disclosed innovation provide for embodiments that allow for depth of an apparatus to be placed below ground freeze lines (at depths at which the typical risk of freezing is abated). In this manner, averting thaw and freeze cycles that may lead to flooding can be averted.

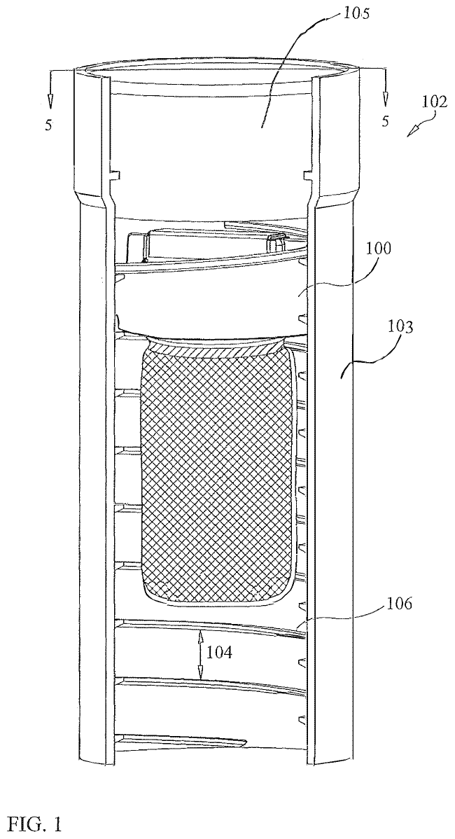

FIGS. 1-13 depict one or more embodiments of a silt and debris catching apparatus (for example apparatus 100 and apparatus 700), that interfaces with one or more embodiments of a valve box assembly as may be known in the art (for example, and without limitation, valve box assemblies 102, 602 and/or 702). When a silt and debris catching apparatus interfaces with a valve box assembly, the silt and debris catching apparatus may retain material that enters the valve box assembly 102, while allowing water to continue through the apparatus and be dispersed below. Water is not captured, nor is it so close to a surface so as to be subject to a freeze condition in most all expected applications of the piping systems. It has been discovered that advantages of the present innovation include embodiments that are at the same time easy to install, require no changes to any valves to be protected, do not require any reworking of valve box assemblies (such as for example to reconfigure basins), and provide a depth of installation that enables an apparatus to operate below a ground freeze line. As is known in the art, a ground freeze line is a depth below ground level that freezing concerns are diminished. Surface or too-near-surface filter systems are susceptible to freezing and losing functionality, especially in particular uses such as fields or streets in which underground piping systems may traverse. Additionally, it has been discovered that in certain embodiments, the presence of an easy and inexpensive field-installable second handle provides benefits of adjustability of a height of a handle such that a field installable second handle may be located near a surface level regardless of most depth below surface level of the position of the catching apparatus. In certain use cases, such as in fields or in remote terrain, the innovation of a second field installable handle provides safety to workers who may need to access the valve protected under the apparatus as various creatures, such as for example snakes, may inhabit the space in a valve box assembly.

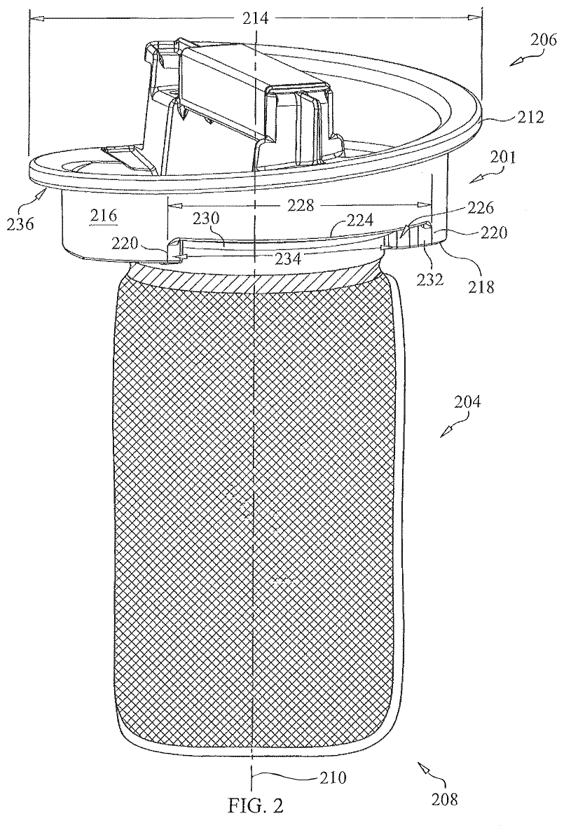

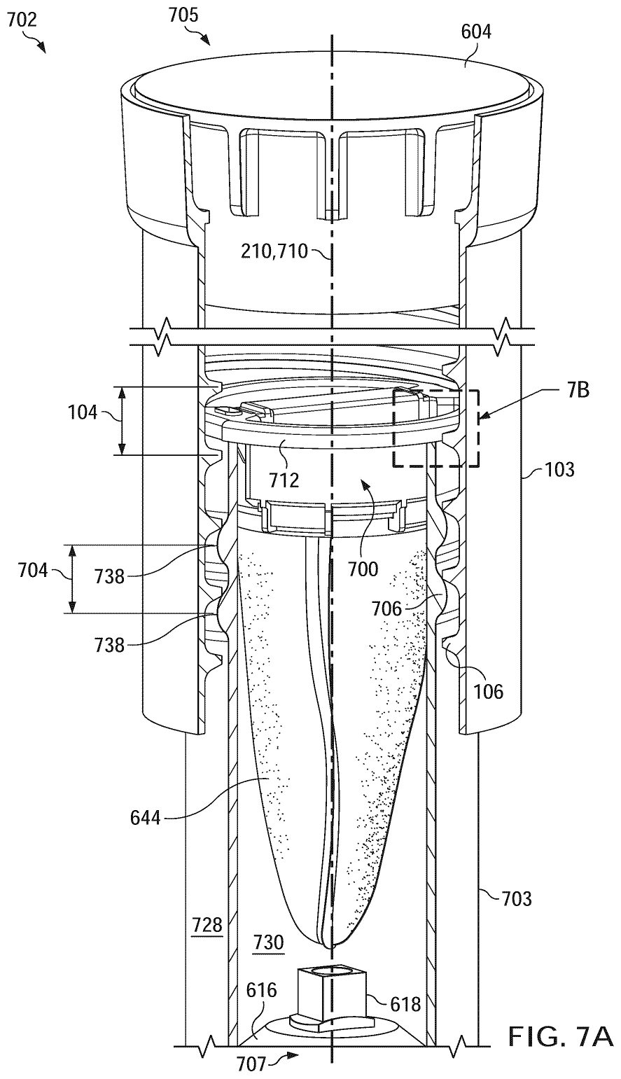

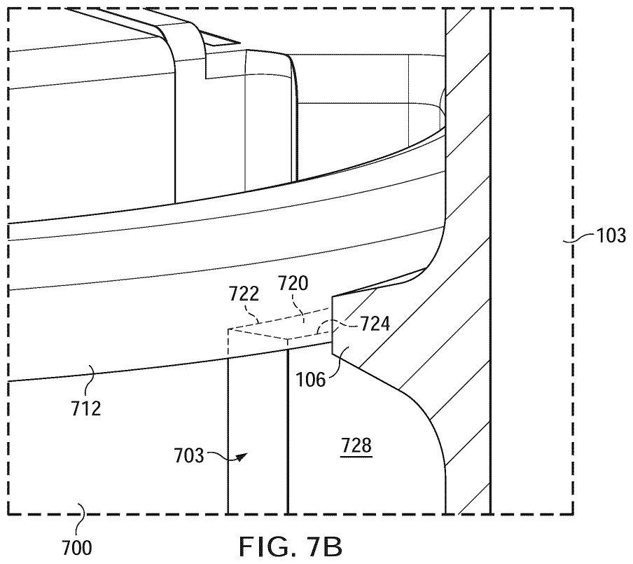

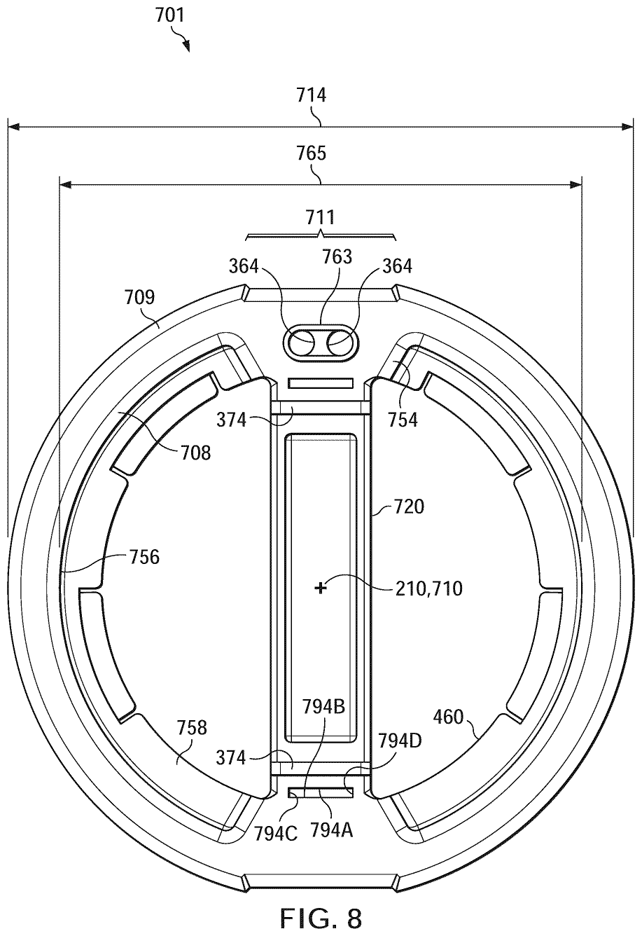

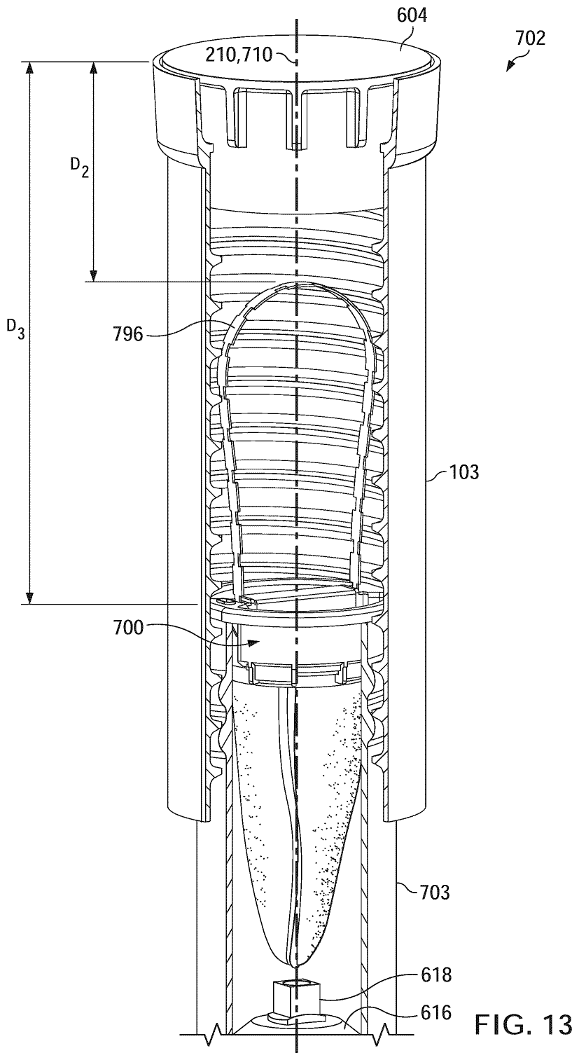

Turning to FIG. 2, an assembled perspective view of a silt and debris catching apparatus that is in accordance with an exemplary embodiment of the present disclosure is shown. As depicted in FIG. 2, an embodiment of a silt and debris catching apparatus 100 comprises a housing component 201, a catchment component 204, a first end 206, a second end 208 opposite the first end 206, and a longitudinal axis 210 between the first end 206 and the second end 208. Some portions of the silt and debris catching apparatus 100 will be described relative to the longitudinal axis 210 and may be used in conjunction with the terms circumferential, or radial, relative to the longitudinal axis 210. It is to be appreciated that a similar description applies to an embodiment of a silt and debris catching apparatus 700 (as shown in FIG. 7A and FIG. 13). As described herein, silt and debris catching apparatus 700 comprises a housing component 701 (details of housing component 701 are shown in FIG. 8 through FIG. 10), a catchment component 204, a first end 705, a second end 707 opposite the first end 705, and a longitudinal axis 710 between the first end 705 and the second end 707. Some portions of the silt and debris catching apparatus 700 will be described relative to the longitudinal axis 710 and may be used in conjunction with the terms circumferential, or radial, relative to the longitudinal axis 710.

As further depicted in FIG. 2, an embodiment of housing component 201 may include a first outer wall 212 that is generally parallel to longitudinal axis 210. First outer wall 212 is a radial outermost portion of the silt and debris catching apparatus 100. As such, the silt and debris catching apparatus 100 has a diameter 214 measured between opposing first outer walls 212 through longitudinal axis 210. Housing component 201 further comprises a second outer wall 216. Second outer wall 216 extends longitudinally to a lower edge 218 of housing component 201. Second outer wall 216 also extends circumferentially to and generally parallel to longitudinal axis 210.

In embodiments, features of an attachment portion of an apparatus (such as for example, apparatus 100 or apparatus 700) may provide for a side-entry/exit snap fit or slide path or be adapted to slidably receive an attachment component (for example, attachment component 470 as described herein). This aspect of the innovation may provide additional in-field ease and time saving as installation (and subsequent removal and emptying of an accumulation) is made simpler with no moving parts or other attachment mechanisms to be concerned about. A slide path made be configured as follows. A first inlet wall 220 and a second inlet wall 222 extend longitudinally from a lower edge 218 to an upper edge 224. First inlet wall 220, second inlet wall 222, and upper edge 224 define an inlet 226 adapted to receive the catchment component 204. Inlet 226 has an outer width 228 measured between first inlet wall 220 and second inlet wall 222 through longitudinal axis 210. A first rounded wall 230 and a second rounded wall 232 extends radially inward from first inlet wall 220 and second inlet wall 222 respectively. Inlet 226 has an inner width 234 measured between first rounded wall 230 and second rounded wall 232. Inner width 234 is slightly less than outer width 228. In embodiments, housing component 201 further comprises a rounded surface 236, as will be discussed in further detail below. in some embodiments, when the silt and debris catching apparatus 100 is installed in the valve box assembly 102, the rounded surface 236 rests upon the thread 106 (also referred to as a set of threads) of a valve body riser 103.

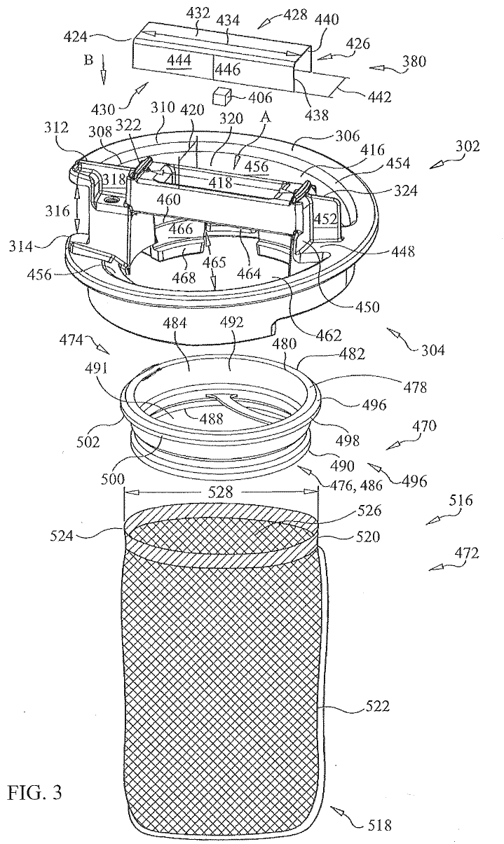

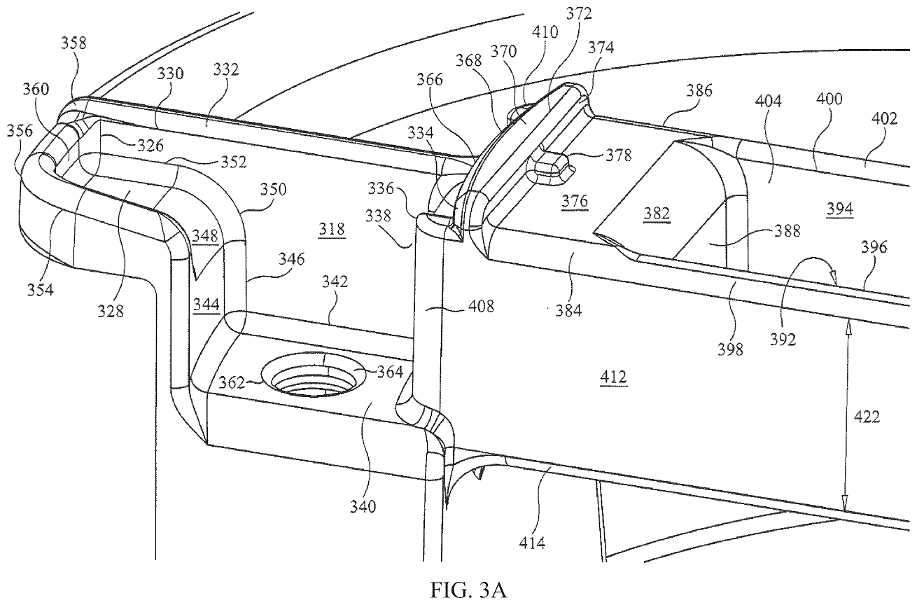

Turning now to FIG. 3, an exploded perspective view of the silt and debris catching apparatus depicted in FIG. 2 is shown. It is to be appreciated that in embodiments, housing component 201 may comprise a first end 302 and a second end 304 opposite the first end 302. Longitudinal axis 210 extends between first end 302 and second end 304. In some embodiments, housing component 201 may comprise a thread follower or helix surface 306. Helix surface 306 is defined by a first inner edge 308, a first outer edge 310, a first terminal end 312 and a second terminal end 314. Helix surface 306 extends around and is generally perpendicular to longitudinal axis 210. In an embodiment, helix surface 306 may extend approximately 360° around longitudinal axis 210. It is envisioned that in other embodiments helix surface 306 may extend more or less than 360° around longitudinal axis 210. It is to be appreciated that in several embodiments, a portion of a top surface, such as the top of helix surface 306, may slope radially inward towards the longitudinal axis 210. The slope of the top portion of helix surface 306 thus directs material (i.e., water, silt, debris, etc.) towards a center of the silt and debris catching apparatus 100 along directional arrow A. It is to be appreciated that in other embodiments, a similar slope may be present in other types of surfaces (such as for example, top surface 748, as will be discussed herein below). As will be discussed in further detail below, the helix surface 306 has a pitch 316 that corresponds to a pitch 104 of a thread 106 of one or more valve body risers 103 of embodiments of valve box assembly 102, as seen in FIG. 1.

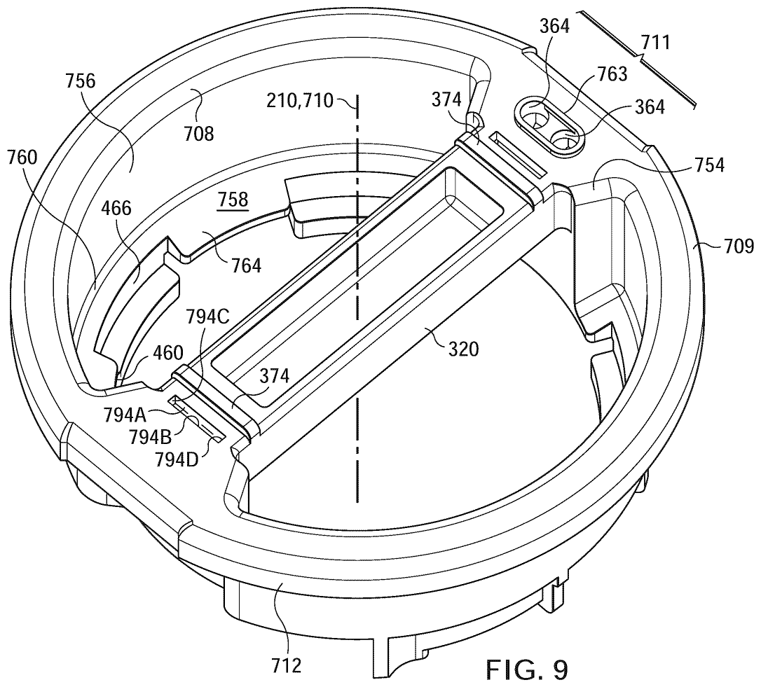

Housing component 201 may further be configured to have a first wall 318 that defines the first terminal end 312 of helix surface 306. First wall 318 extends radially inward from first outer edge 310 to a first handle 320. In embodiments, first handle 320 includes a first side 322 and a second side 324 opposite the first side 322 that is structurally identical to first side 322. Accordingly, for brevity, similar reference numerals on first side 322 of first handle 320 refer to similar elements on the second side 324 and vice versa. It is to be appreciated that other first handle configurations are contemplated and may include other configurations as discussed herein (and for example as shown in FIG. 7A through FIG. 13). It is to be further appreciated that transitions of a first handle to the body of housing component 201 (or 701) may vary without deviating from the innovative aspects presented herein. For example, turning briefly to FIG. 8, transition 754 provides a radially expanding transition from each side of first handle 320 to the body of housing component 701, with blending from first handle 320 to first inner wall 756 and inner sloped surface 758 as best shown in FIG. 9.

In a particular detailed embodiment of housing component 201, as depicted in FIG. 3A, a first vertical terminal end 326 of first wall 318 extends longitudinally from a first surface 328 to a first edge 330 of a second surface 332. First edge 330 extends radially inward from first outer edge 310 of helix surface 306 to a curved portion 334 of a second wall 336 of first handle 320. A second vertical terminal end 338 of first wall 318 extends longitudinally from first edge 330 to a third surface 340. A first horizontal terminal end 342 of first wall 318 extends radially outward from second wall 336 to a third wall 344. A third vertical terminal end 346 of first wall 318 extends longitudinally from third surface 340 to a first curved wall 348. A curved end 350 of first wall 318 convexly curves radially outward from third vertical terminal end 346 to a second horizontal terminal end 352. Second horizontal terminal end 352 extends radially outward from a first curved wall 348 to first outer edge 310 of helix surface 306.

Second wall 336 and third wall 344 extend longitudinally and generally parallel to longitudinal axis 210. First surface 328, second surface 332, and third surface 340 each extend radially and generally perpendicular to longitudinal axis 210.

A fourth surface 354 is defined by a second outer edge 356 and a second inner edge 358. Fourth surface 354 extends generally perpendicular from first wall 318 and convexly curves approximately 90° to third wall 344. A fourth wall 360 extends longitudinally from second inner edge 358 to first surface 328. It is to be appreciated that first surface 328 extends radially inward from fourth wall 360 to first curved wall 348. First surface 328 also extends between fourth wall 360 and first wall 318. First curved wall 348 also convexly curves radially inward and downward from first surface 328 to third wall 344. Third wall 344 extends longitudinally from first curved wall 348 to third surface 340.

Continuing, third surface 340 extends radially inward from third wall 344 to second wall 336. Third surface 340 also extends between first wall 318 and second outer edge 356. A surface (not shown) that is structurally identical to third surface 340 exists on an opposing side of first wall 318. In embodiments, third surface 340 may also include an annular edge 362. Annular edge 362 defines a removable knockout plug 364. Knockout plug 364 may be a molded member of housing component 201 that may be removed by applying a force parallel to the longitudinal axis 210. When knockout plug 364 has been removed, annular edge 362 defines a first opening of a bore. The bore extends from the first opening to a second opening on a surface that opposes third surface 340. It is to be appreciated that the bore is adapted to accommodate a tracer wire that is coupled to a pipe located at a bottom of a valve box assembly. The tracer wire may extend from the pipe through the bore and to the surface where it is accessible to a user. In other embodiments such as housing component 701, as best seen in FIG. 8, annular edge 763 may be configured to be a singular unbroken ridge at a generally planar surface. It is to be appreciated that knockout plug 364 may be molded separately or be supplied in a replacement capacity and may be configured to suit various embodiments to seal the bore. In other words, annular edge 362 defines at least one selected off-center inner diameter, with a centerline parallel to a centerline of the housing component (that is, longitudinal axis 210/710) and that defines a bore operable to support a tracer wire passing through the housing component.

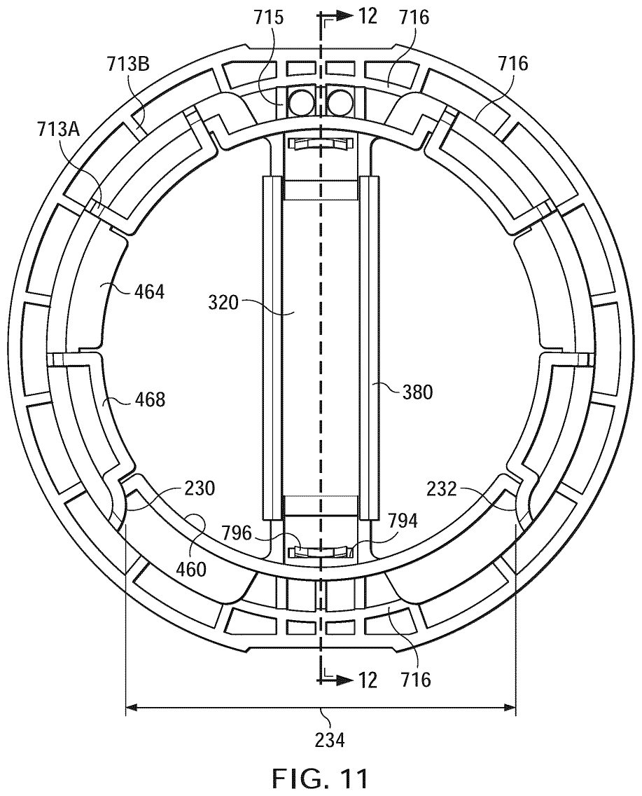

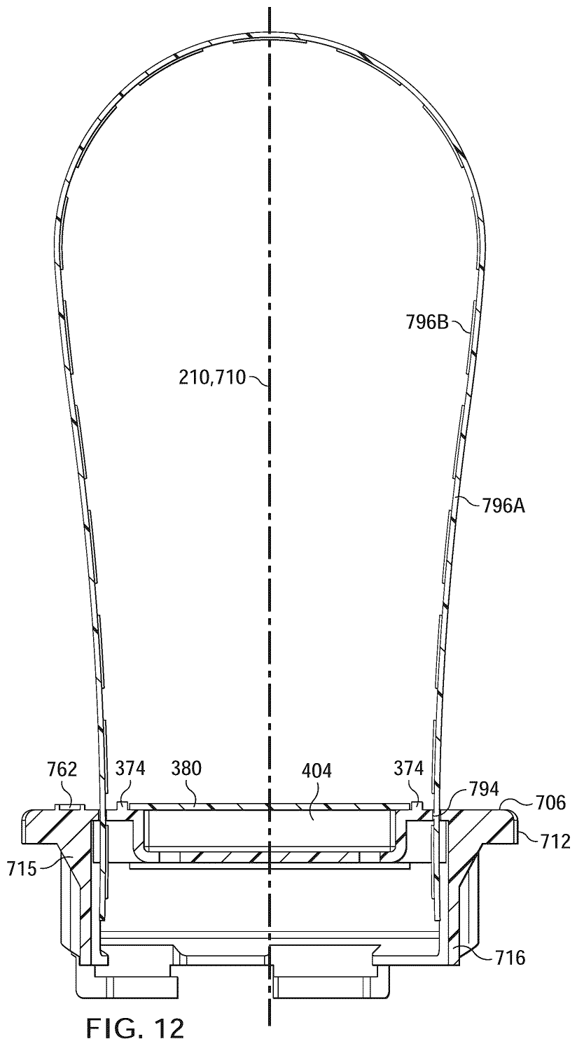

Continuing with a detailed embodiment of housing component 201, second wall 336 of first handle 320 extends longitudinally from third surface 340. Curved portion 334 of second wall 336 convexly curves radially inward to a second curved wall 366. Second curved wall 366 extends longitudinally from the curved portion 334 of second wall 336 to a curved edge 368. A fifth surface 370 extends from curved edge 368 to an edge 372. A fifth wall 374 extends longitudinally from edge 372 to a sixth surface 376. A locking notch 378 extends longitudinally from sixth surface 376 and extends radially inward from fifth wall 374. As will be discussed in further detail below, locking notch 378 receives a complementary portion of a cover 380 (as can be seen in FIG. 3) thereby securing cover 380 to housing component 201. In other embodiments, for example as with housing component 701 and as best seen in FIG. 8 and FIG. 9, radially outward of the center of wall 374 may be opposing pairs for walls 794A and 794B parallel to wall 374, as well as 794C and 794D perpendicular to wall 374 that define a pair of slots 794. As discussed herein below, slots 794 may provide an interface for a field installable second handle 796, as best seen in FIG. 12. In other words, housing component 701 has first handle 320 defining a pair of slots 794 spaced apart from one another. Field installable second handle 796 may generally be configured to be adjustable with a pliable continuous portion 796A and a pliable intermittent portion 796B. It is to be appreciated that insertion of field installable second handle 796 through slot 794 is easily completed in the field, with adjustability provided by an amount of field installable second handle 796 fitted through one or both slots 794 so as to provide field installable second handle with a depth D₂ from ground level and above the housing component 701 that rests at a depth D₃. It is to be appreciated that depth D₃ may and likely will vary over miles of a piping system, depth D₂ can be controlled to provide ease of removal. Ease of installation is as simple as dropping the disclosed apparatus (for example, apparatus 100 or apparatus 700) into an open valve box assembly. It is to be appreciated that field installable second handle 796 may act as a ratchet (or akin to a zip tie). In the embodiment pictured, intermittent portion 796B is pliable so as to be easily pushed through slot 794 but reverts to its slightly curved shape providing strength against being pulled out. It is contemplated that other configurations (not shown) can serve this purpose (for example, intermittent portion 796B can be configured to have a leading slope and a sharper retreat towards continuous portion 796A). It is to be appreciated that field installable second handle 796 will be configured to be able to withdraw an apparatus (100, 700) when the apparatus is full of silt or debris or both. In embodiments, field installable second handle 796 may be configured to be able to withstand pull force upwards for emptying the apparatus with debris piled up over the apparatus in the interior of valve box riser 103 without detaching. As best seen in FIG. 13, D₂ provides a distance that can be easily retrievable by hand at or near surface level while D₃ safely remains below a freeze line. It is also to be appreciated that cover 380 may be configured to snap fit over the height of first handle 320 (as discussed herein, and also shown in FIG. 11).

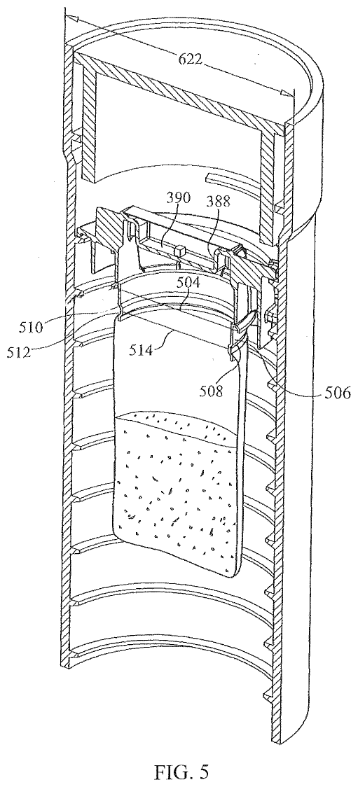

Continuing with a detailed embodiment of housing component 201, sixth surface 376 extends radially inward from fifth wall 374 to a curved edge 382. Sixth surface 376 further extends between a first outer rounded edge 384 and a second outer rounded edge 386. Curved edge 382 curves downward and radially inward from sixth surface 376 to a seventh wall 388. As depicted in FIG. 5 (which provides an isometric section view), seventh wall 388 extends longitudinally from curved edge 382 to an inner surface 390. Inner surface 390 extends radially inward from seventh wall 388 to an opposing seventh wall 388. Returning to FIG. 3A, curved edge 382 and seventh wall 388 extend between a first inner wall 392 and a second inner wall 394. First inner wall 392 extends longitudinally from inner surface 390 to an edge 396 of a seventh surface 398. Second inner wall 394 extends longitudinally from inner surface 390 to an edge 400 of an eighth surface 402.

Opposing curved edges 382, opposing seventh walls 388, inner surface 390, first inner wall 392 and second inner wall 394 define a channel 404. In other embodiments, it is to be appreciated that channel 404 may be defined by different but similar features (as seen, for example in FIG. 12). Channel 404 may be appropriately dimensioned so as to accommodate a radio-frequency identification (RFID) chip or tag 406 (as seen in FIG. 3) within channel 404. RFID chip 406 may be placed within channel 404 and secured within channel 404 by cover 380. It is to be appreciated that RFID chip 406 may emit a unique radio frequency that may be read by an RFID chip reader (not shown) when the reader is within a predetermined range of RFID chip 406. As such, when housing component 201 and RFID chip 406 are within a valve box assembly, such as valve box assembly 102, 602, 702 or the like, a user may locate the respective valve box assembly with the RFID chip reader when the RFID chip reader is within range of RFID chip 406. Furthermore, the RFID chip reader may store data associated with RFID chip 406 (i.e., when the valve was last accessed, how often the valve has been accessed within a given time period, etc.), as discussed herein.

In another embodiment, the RFID tag 406 may be located elsewhere within a respective valve box assembly (i.e., on a surface of the valve box assembly, affixed on an underside of a valve box cover 604 (as discussed herein below), on a valve within a valve box assembly or on a pipe within a valve box assembly).

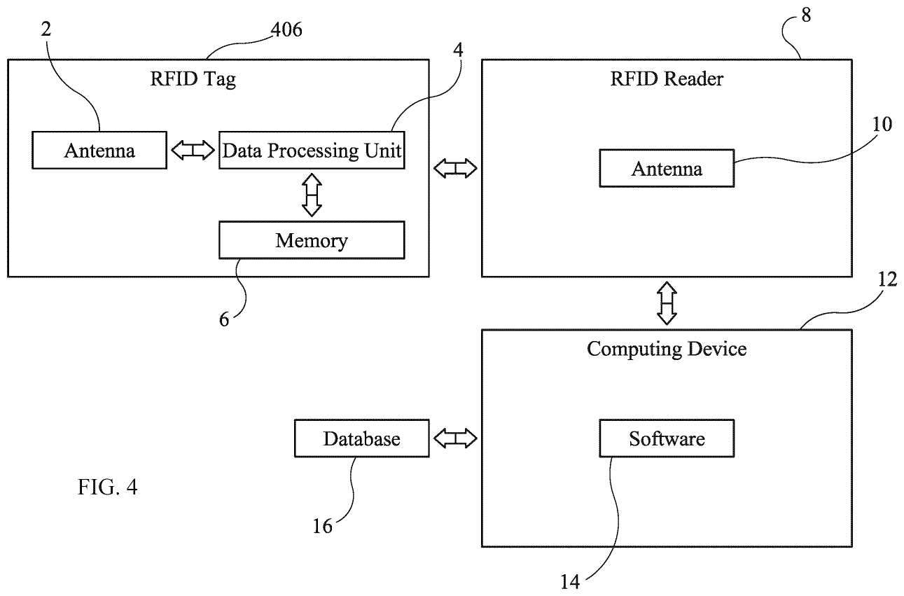

Briefly turning to FIG. 4, the RFID tag 406 includes an antenna 2, a data processing unit 4 in communication with the antenna 2, and a memory 6 in communication with the data processing unit 4. In one embodiment, the data processing unit 4 may be an application specific integrated circuit (ASIC) and the memory 6 may include a non-transitory computer readable storage medium that stores data relating to the silt and debris catching apparatus 100 or the valve box assembly 102. It is to be appreciated that while the embodiment discussed uses the terminology of valve box assembly 102, other valve box assemblies, such as without limitation valve box assembly 602 of valve box assembly are as applicable to the disclosed innovative concepts.

The antenna 2 receives an electromagnetic signal or an electromagnetic wave emitted from an antenna 10 of an RFID reader or RFID chip reader 8. When in range of the emitted electromagnetic signal, the antenna 2 of the RFID tag 406 receives the electromagnetic signal. In response to receiving the electromagnetic signal from the RFID reader 8, the antenna 2 of the RFID tag 406 sends a signal to the data processing unit 4. In response to receiving the signal from the antenna 2 of the RFID tag 406, the data processing unit 4 extracts data from the memory 6 and instructs antenna 2 of the RFID tag 406 to emit a radio wave that includes the data. The RFID reader 8 may receive the data and may then transmit the data to a computing device 12 with RFID computer software 14. The RFID computer software 14 may include computer-executable instructions stored on a non-transitory computer readable storage medium of the computing device 12 and may be executable by a microprocessor of the computing device 12. The RFID computer software 14 may allow a user to read and/or modify the received data. The computing device 12 may have local network access or internet access. In one embodiment, the RFID reader 8 may include the computing device 12. In another embodiment, the RFID computer software 14 may be stored on a different computing device 12 located in a different location. In this embodiment, the RFID reader 8 may transmit the data from the RFID tag 406 to the computing device 12 with the RFID computer software 14 via a wired or wireless connection.

In one embodiment, the RFID tag 406 is a passive RFID tag, wherein the RFID tag 406 does not include a power source. In this embodiment, the RFID tag 406 uses energy from the electromagnetic signal transmitted by the RFID reader 8 to power the RFID tag 406 in order to emit the radio wave with the data stored in the RFID tag 406. In another embodiment the RFID tag 406 is an active RFID tag, wherein the RFID tag 406 includes a power source. In this embodiment, a battery may power the RFID tag 406 in order to emit the radio wave with the data stored in the RFID tag 406.

In one embodiment, the RFID reader 8 may be a handheld device. In this embodiment, a user may carry the RFID reader 8 while the reader is in a scanning mode. In scanning mode, the RFID reader 8 has a reading range. The reading range corresponds to a distance away from the RFID reader 8 that the electromagnetic wave travels. When the RFID tag 406 is within the reading range, the antenna 2 of the RFID tag 406 may receive the electromagnetic wave thereby allowing the RFID tag 406 to respond. This process may aid a user in locating the RFID tag 406 and therefore locate a silt and debris catching apparatus 100 or a valve box assembly 102. The RFID tag 406 emits a unique radio-frequency that may be read by an RFID chip reader 8. The RFID chip reader 8 may read the frequency when the RFID chip reader 8 is within a range of the RFID tag 406. As such, when the housing component 201 and the RFID tag 406 are within the valve box assembly 102, a user may locate the valve box assembly 102 by determining an RFID chip reader 8 is within range of the RFID tag 406.

For example, the RFID reader 8 may include computer software with computer-executable instructions stored on a non-transitory computer readable storage medium that may be executable by a microprocessor of the RFID reader 8 that enables a user to increase or decrease a range of the RFID reader 8 by increasing or decreasing a power output to the antenna 10 of the RFID reader 8. In this example, a user may walk with the RFID reader 8 in scanning mode until an RFID tag 406 responds to the emitted signal. The user may then reduce the reading range of the RFID reader 8 until the RFID tag 406 no longer responds to the emitted signal. The user may again walk with the RFID reader 8 in scanning mode until the RFID tag 406 again responds to the emitted signal. The user may repeat these steps until a silt and debris catching apparatus 100 or a valve box assembly 102 is located.

In another embodiment, the RFID reader 8 may be fixed on a mounting device. In one instance, the RFID reader 8 may continuously emit the electromagnetic signal and one or more RFID tags 406 within the reading range of the RFID reader 8 may continuously respond to the emitted electromagnetic signal. In another instance, the RFID reader 8 may periodically emit the electromagnetic signal and one or more RFID tags 406 within the reading range may respond to the emitted electromagnetic signal.

In one embodiment, the RFID tag 406 may be a read-only RFID tag. In this embodiment, the memory 6 of the RFID tag 406 is a read-only memory. In this embodiment the data in the memory 6 is written to the memory 6 and cannot be later modified.

In one instance, the data in the read-only memory 6 of the RFID tag 406 includes a serial number. The serial number identifies the silt and debris catching apparatus 100 or the valve box assembly 102. When read by the RFID computer software 14, the serial number may provide the RFID computer software 14 access to a database 16 stored in a non-transitory computer readable storage medium. The database 16 may be locally stored on the same computing device 12 that has the RFID computer software 14 or may be remotely stored on different device that may be accessed by the computing device 12 with the RFID computer software 14 over a local network connection or an internet connection.

The database 16 may include editable and/or static data relating to the slit and debris catching apparatus 100 or the valve box assembly 102. For instance, the data in the database 16 may include a date and/or a time the valve box assembly 102 was accessed, a date and/or a time that the silt and debris catching apparatus 100 was inspected, a date and/or a time that the silt and debris catching apparatus 100 was emptied, a geographic location of the silt and debris catching apparatus 100 and/or the valve box assembly 102 including global positioning system (GPS) coordinates, a status of a valve within the valve box assembly 102 (i.e., open or closed), a pipe diagram showing a valve and a pipe within the valve box assembly 102 and one or more other related valves (i.e., showing the layout of other valve box assemblies, other valves, and other pipes in communication with the valve box assembly), a fluid flow state (i.e., if fluid is flowing through a valve within the valve box assembly 102 or not), a type of fluid that flows through a valve within the valve box assembly 102 (i.e., gas or water), what a valve within the valve box assembly 102 effects (i.e., what a valve turns on or off), and other data associated with the silt and debris catching apparatus 100 and the valve box assembly 102.

In this instance, wherein the serial number provides access to a database 16 with editable data, a user may access the editable data with the serial number via the RFID computer software 14 and edit the editable data based on a corresponding event. For example, a user may access a valve box assembly 102 in order to inspect a silt and debris catching apparatus 100. Upon inspection, a user may find that the silt and debris catching apparatus 100 retains an amount of material. The user may then remove the silt and debris catching apparatus 100 from the valve box assembly 102 and empty the silt and debris catching apparatus 100. A user may then use an RFID reader 8 to obtain a serial number associated with the recently emptied silt and debris catching apparatus 100 or the recently accessed valve box assembly 102 and used the obtained serial number to access a database 16 with RFID computer software 14. The user may then update a date and time the valve box was accessed and a date and time the silt and debris catching apparatus was emptied with the current date and time.

In this instance, wherein the data in the read-only memory 6 includes static data relating to the silt and debris catching apparatus 100 or to the valve box assembly 102, a user may read the static data stored in the read-only memory via the RFID computer software 14. For example, a user may locate a valve box assembly 102 containing a silt and debris catching apparatus 100 that includes the RFID tag 406. When the RFID tag 406 is within reading range of the RFID reader 8, the user may place the RFID reader 8 into scanning mode. Since the RFID reader 8 is within range of the RFID tag 406, the RFID reader 8 may receive the static data in the read-only memory 6 from the RFID tag 406. In this instance, the RFID reader 8 may include the RFID computer software 14. As such, the RFID reader 8 may display the static data (i.e., a type of fluid that flows through a valve within the located valve box assembly 102).

In another embodiment, the RFID tag 406 may be a read/write RFID tag. In this embodiment, the memory 6 of the RFID tag 406 is a read/write memory. In this embodiment the data in the memory 6 is written to the memory 6 and can be later modified.

In this embodiment, the data in the read/write memory 6 may include static data and editable data. For instance, the data in the read/write memory 6 may include a date and/or a time the valve box assembly 102 was accessed, a date and/or a time that the silt and debris catching apparatus 100 was inspected, a date and/or a time that the silt and debris catching apparatus 100 was emptied, a geographic location of the silt and debris catching apparatus 100 and/or the valve box assembly 102 including global positioning system (GPS) coordinates, a status of a valve within the valve box assembly 102 (i.e., open or closed), a pipe diagram showing a valve and a pipe within the valve box assembly 102 and one or more other related valves (i.e., showing the layout of other valve box assemblies 102, other valves, and other pipes in communication with the valve box assembly 102), a fluid flow state (i.e., if fluid is flowing through a valve within the valve box assembly 102 or not), a type of fluid that flows through a valve within the valve box assembly 102 (i.e., gas or water), what a valve within the valve box assembly 102 effects (i.e., what a valve turns on or off), and other data associated with the silt and debris catching apparatus 100 and the valve box assembly 102.

In one example, a user may desire to edit data in read/write of an RFID tag 406 that is within range of an RFID reader 8. In this example, the user may use a computing device 12 that is wirelessly connected to the RFID reader 8 and the RFID reader 8 may be stationary and fixed on a mounting device. The user may use the computing device 12 to direct the RFID reader 8 to emit a first electromagnetic signal. The RFID tag 406 may receive the first electromagnetic signal and may respond with the editable data stored in the read/write memory 6 of the RFID tag 406. The user may then use RFID computer software 14 on the computing device 12 to edit the editable data and direct the RFID reader 8 to emit a second electromagnetic signal to the RFID tag 406. The second electromagnetic signal may contain the newly edited data and instructions to save the newly edited data in the read/write memory 6 of the RFID tag 406. In this example, a user may remotely shut off a valve located within a valve box assembly 102 within a RFID tag 406 that includes editable data including a valve status. In order to reflect the status change of the valve, the user may edit the data to reflect that the valve has been shut off and store this status change in the read/write memory 6 of the RFID tag 406.

In one embodiment, a change in the data stored in the memory 6 of the RFID tag 406 or in the database 16 accessible with the serial number, may cause the RFID computer software 14 to automatically edit other data in the memory 6 or the database 16.

For example, a first valve box assembly 102 (with a valve connected to a pipe within the valve box assembly 102) may be part of an irrigation system on a farm. The irrigation system may include several other valve box assembles 102 (with several other valves connected to several other pipes within the several other valve box assemblies 102). A user may manually close the valve within the valve box assembly 102 thereby cutting off a water supply to other parts of the irrigation system. As a result, water may not be flowing through a second valve box assembly 102 located downstream from the first valve box assembly 102. In order to reflect this change in the RFID tag 406 of the first valve box assembly 102, the user may use the RFID computer software 14 to change a valve status stored in the database 16 or stored in the memory 6 of the RFID tag 406 from “on” to “off” for the corresponding valve within the valve box assembly 102. In response to this change, the RFID computer software 14 may automatically change the valve fluid flow state from “flow” to “no flow” as shutting off the upstream valve prevents water from flowing downstream to the second valve box assembly 102. This change may be made in the memory 6 of the RFID tag 406 or in the database 16.

Furthermore, in one embodiment, the RFID tag 406 may be waterproof. In this embodiment, the RFID tag 406 may continue to operate when water enters the valve box assembly 102 and contacts the RFID tag 406. In embodiments, RFID tag 406 may be coupled with a sensor 407 (not shown). Sensor 407 may be configured to determine a state of the apparatus. Contemplated states include sensing whether a catchment component is full or torn. Sensing whether a catchment component is full may be by manner of weight or material reaching a certain volume. Sensing whether a catchment component is torn may be by manner of lack of deceleration of material within a certain zone.

Returning to the detailed embodiment of housing component 201 and with reference to FIG. 3A, second wall 336 further extends generally perpendicular from first wall 318 to a first rounded corner 408 and a second rounded corner 410. First rounded corner 408 convexly curves approximately 90° about longitudinal axis 210 to a sixth wall 412 and second rounded corner 410 convexly curves approximately 90° about longitudinal axis 210 to an opposing wall (not shown). The opposing wall is structurally identical to sixth wall 412. Sixth wall 412 extends longitudinally between first outer rounded edge 384 and another edge 414. Sixth wall 412 further extends between opposing first rounded corners 408 and the opposing wall extends between opposing second rounded corners 410.

As depicted in FIG. 3A, in embodiments, opposing second walls 336, opposing first rounded corners 408 and opposing second rounded corners 410, and opposing sixth walls 412, define an outer surface 416 of first handle 320. It is to be appreciated that one or more of these features may define other configurations of a first handle in other embodiments. In embodiments, a length 418 of first handle 320 may be measured between opposing fifth walls 374 through the longitudinal axis 210. In some other embodiments, length 418 may define a portion of first handle 320 in that other features may be located in relation to length 418. In embodiments, length 418 may signify transition from first handle 320 to (and into) housing component 201. It is to be appreciated that these transitions may be configured in a number of ways, such as in FIG. 8, as discussed herein in relation to the embodiment of housing component 701. It is to be appreciated that descriptions of first handle 320 between walls 374 may be similar across various embodiments including a width 420 of first handle 320 that is measured between sixth wall 412 and the opposing wall through the longitudinal axis 210. A height 422 of first handle 320 may be measured between a top of first outer rounded edge 384 and a bottom of edge 414 and parallel to the longitudinal axis 210 (as seen in FIG. 3A).

With continued reference to FIG. 3, cover 380 may comprise a first horizontal end 424, a second horizontal end 426 opposite the first horizontal end 424, a first vertical end 428, and a second vertical end 430 opposite the first vertical end 428. Cover 380 further comprises a first surface 432. First surface 432 has a length 434 measured between first horizontal end 424 and second horizontal end 426 through a longitudinal axis, for example, longitudinal axis 210. It is to be appreciated that length 434 is generally complementary to length 418 of first handle 320. Cover 380 further comprises a second surface 436 that opposes first surface 432. Additionally, a first inner surface 438 and a second inner surface 440 extend longitudinally from second surface 436. Cover 380 has a width 442 measured between first inner surface 438 and second inner surface 440. Width 442 is generally complementary to width 420 of first handle 320. In embodiments, the surface may comprise a notch receiving component (not shown) that is generally complementary to and adapted to receive locking notch 378. Cover 380 further comprises a first outer surface 444 that opposes first inner surface 438. First outer surface 444 extends longitudinally from first surface 432 to second vertical end 430. First outer surface 444 has a height 446 measured between first vertical end 428 and second vertical end 430. It is to be appreciated that height 446 is generally complementary to height 422 of first handle 320 in that in embodiments, cover 380 may provide a snap fit to first handle 320 as height 422 fits within height 446. In other words, when a downward force is applied along the directional arrow B such that cover 380 is placed over first handle 320, in embodiments, the notch receiving component of cover 380 may physically couple to locking notch 378.

In embodiments, for example as shown in FIG. 5, since first surface 432 has a generally complementary length 434 to length 418 of first handle 320, first horizontal end 424 and second horizontal end 426 abut opposing fifth walls 374. Since the first outer surface 444 has a height 446 that is generally complementary to the height 422 of the first handle 320, the second vertical end 430 of the cover 380 does not extend beyond the edge 414 of the first handle 320. Stated otherwise, the cover 380 does not extend longitudinally beyond first handle 320. As further depicted in FIG. 2 and FIG. 5, when cover 380 is secured into place, second surface 436 rests upon and physically contacts sixth surface 376 of first handle 320. As a result, when the silt and debris catching apparatus 100 is within a respective valve box assembly 102, 602, 702 or the like, the cover 380 may prevent material (i.e., water, silt, debris, etc.) that may compromise the RFID chip 406 from entering the channel 404. In embodiments, cover 380 may be released from the locking notch 378 by an upward force opposite the movement arrow B. In other embodiments a force (not shown) may be employed to spread the cover lower edges wider than first handle width 420, thereby allowing the cover 380 to disengage from first handle 320. Turning briefly to FIG. 8, FIG. 9, FIG. 11, and FIG. 12, first handle 320 and cover 380 are shown in various figures of embodiment 701, indicating the configuration is suitable for multiple embodiments.

In embodiments, a generally perpendicular portion 448 of helix surface 306 extends radially inward and generally perpendicular to longitudinal axis 210. In other embodiments, generally perpendicular portion 448 may be configured as related to a different surface (for example and as discussed herein below, the generally perpendicular top surface 748).

Returning to the detailed embodiment of housing component 201, an opposing second wall 450 extends longitudinally from perpendicular portion 448. Opposing second wall 450 extends generally parallel to longitudinal axis 210. An opposing first wall 452 extends radially outward from opposing second wall 450 and extends longitudinally from perpendicular portion 448. In other embodiments, for example in embodiments without helix surface 306 as described herein, generally perpendicular portion 448 may extend radially inward and generally perpendicular to the longitudinal axis 210. In other words, the surface may be provided with a slight inward slope to as to provide an advantage of assisting water carried debris into the central portion of the apparatus.

A rounded inner edge 454 curves radially inward and downward from first inner edge 308 to a first inner wall 456. The first inner wall 456 extends longitudinally from the rounded inner edge 454 to an inner sloped surface 458 the inner sloped surface 458 extends radially inward and downward from the first inner wall 456 towards the longitudinal axis 210 to a second inner edge 460. The first inner wall 456 extends generally parallel to the longitudinal axis 210 and generally perpendicular to the helix surface 306.

Turning briefly to FIG. 8, in another embodiment, housing component 701 may comprise a top surface 748. Top surface 748 is defined by a first inner edge 708 and a first outer edge 709. First outer edge 709 demarcates a first outer cylindrical wall 712 that is generally parallel to a longitudinal axis 710, such as similar to longitudinal axis 210. Diameter 714 is measured between opposing first outer walls 712 through the longitudinal axis. It is to be appreciated that housing component 701 may have a smaller outer diameter than the comparable outer diameter for housing component 201. First inner edge 708 curves radially inward and downward to a first inner wall 756. First inner wall 756 extends longitudinally from the rounded inner edge 708 to an inner sloped surface 758. Inner sloped surface 758 extends radially inward and downward from the first inner wall 756 towards the longitudinal axis 710 to a second inner edge 460. The first inner wall 756 extends generally parallel to the longitudinal axis 710 and generally perpendicular to the top surface 748. It is to be appreciated that housing component 701 may have a smaller inner diameter than the comparable inner diameter for housing component 201.

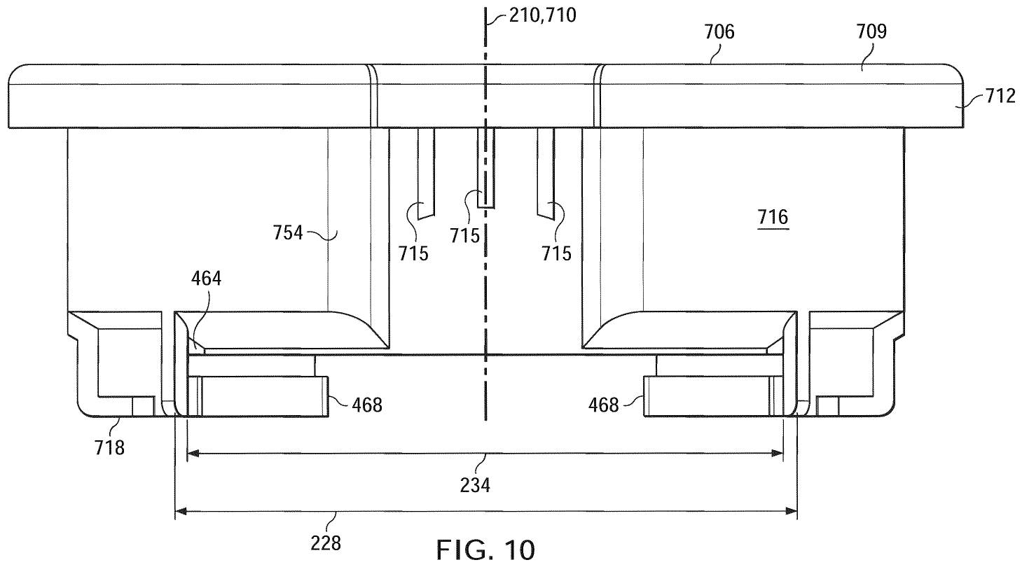

Second inner edge 460 defines an opening 462 of the housing component 701. Opening 462 has a diameter 465 measured between opposing second inner edges 460 and through the longitudinal axis 710. A plurality of first radially inward extending bosses 464 extend radially inward from the second inner edge 760 toward the longitudinal axis 710. It is to be appreciated that the embodiment of housing component 701 may be configured to be generally similar to housing component 201 for lower portions of the component, with some differences in a second outer wall (excepting portions removed for manufacturing ease or fabricating improvements). Thus, features of an attachment portion as described above for the embodiment of housing component 201 are generally applicable to the embodiment of housing component 701. Feature numbers repeated from the earlier disclosure are thus pertinent in portions of multiple embodiments. First radially inward extending bosses 464 are generally equidistantly spaced around the opening 462. A second inner wall 466 extends longitudinally from the second inner edge 760 and is generally parallel to the longitudinal axis 710. A plurality of second radially inward extending bosses 468 extend radially form the second inner wall 466. The second radially inward extending bosses 468 are radially offset from the first radially inward extending bosses 464. It is to be appreciated that a slide path as discussed above may limit the number and location of the plurality of second radially inward extending bosses 468. FIG. 10 and FIG. 11 provide views for housing component 701 akin to FIG. 2 and FIG. 3 for housing component 201.

In one particular embodiment, the housing component 701 is formed from a uniform, monolithic member formed from a suitably rigid material so as to withstand deformation when the housing component 701 is placed within a respective valve box assembly 102, 602, 702 or the like. The housing component 701 may be fabricated from a polymer material; however other rigid materials are entirely contemplated. Furthermore, the integral structure of the housing component 701 may be formed from multiple elements having similar configurations as one having ordinary skill in the art would understand. It is contemplated that some embodiments have benefits of being formed in a single unitary process. These embodiments may present further advantages than other embodiments in view of manufacturing processes. In other words, some embodiments may, for example, have a slidably receiving portion (for example, 220, 224, 226, 228, 230, 232, 234, and the like) of housing component (for example, housing component 201 or housing component 701) to be formed of a one-piece construction with first handle 320. It is further contemplated that in some embodiments, processing techniques related to monolithic members may provide for alterations to the disclosed details above. For example, considerations of removing exterior walls, or portions thereof and replacing portions with ribs may provide for strength while reducing mold complexity and wall thickness concerns.

In an embodiment as best seen in FIG. 11, manufacturing improvements of the type indicated are visible in second outer wall 716 of housing component 701. In portions, second outer wall 716 extends longitudinally to a lower edge 718 of housing component 701 (as best seen in FIG. 10). Second outer wall 716 also extends circumferentially to and generally parallel to longitudinal axis 210. It is to be appreciated that second outer wall 716 may extend fully in a circumferential manner around longitudinal axis 710, but not for a full vertical direction parallel to longitudinal axis 710 and instead may employ a number of ribs 713A, 713B, and 715 for increased strength and improved manufacturing control.

Turning to FIG. 11, ribs 713A and 713B can be seen, each radially configured from longitudinal axis 710. Ribs 713A may extend from second outer wall 716 outward to first outer wall 712. It has been discovered that advantages of reducing weight while strengthening the portion of housing component 701 in the interface area between housing component 701 and lower riser 703 (as described herein below) are obtained. Ribs 713B may extend from second outer wall (or be stepper inward at lower edge 718) radially inward, concurrently with or near second radially inward extending bosses 468. A plurality of ribs 715 may be located extending from or near the walls that comprise first handle 320, on the opposing side of transition 754 in a non-radial manner, and generally extending from a bottom surface generally at the same level of the bottom of first handle 320 and angling outward and upward to a partial outer wall, and further from the partial portion of second outer wall to a first outer wall. In some embodiments, as best seen in FIG. 8 and FIG. 9, an overflow surface 711 may be positioned along first outer wall 712 at opposing ends of first handle 320, providing an outer rounded surface, parallel to the sixth wall 412 of first handle 320 that slopes downward, with a width from an outer edge of one overflow surface 711 to an opposing outer edge of overflow surface 711 less than outer diameter 714.

With continued reference to FIG. 3, catchment component 204 comprises an attachment component 470 and a filtration component 472. It is to be appreciated that the disclosure herein is applicable to the embodiment of housing component 701 as well, but for simplicity, the embodiment of housing component 201 is referenced.

The attachment component 470 comprises a first end 474 and a second end 476 opposite first end 474. The longitudinal axis 210 proceeds between first end 474 and second end 476. A first annular surface 478 is defined by a first inner annular edge 480 and a first outer annular edge 482. First annular surface 478 defines first end 474. First annular surface 478 extends circumferentially around and generally perpendicular to longitudinal axis 210. First inner annular edge 480 defines a first opening 484. It is to be appreciated that when the attachment component 470 is coupled to the housing component 201, the first opening 484 is in open communication with the opening 462 of the housing component 201.

Attachment component 470 further comprises a second annular surface 486 that defines second end 476 and extends circumferentially around and generally perpendicular to the longitudinal axis 210. Second annular surface 486 is defined by a second inner annular edge 488 and a second outer annular edge 490. Second inner annular edge 488 defines a second opening 491. An inner surface 492 extends from first inner annular edge 480 to second inner annular edge 488. Inner surface 492 extends circumferentially around and generally parallel to the longitudinal axis 210. The first inner annular edge 480, the inner surface 492, and the second inner annular edge 488 define a bore 494.

The attachment component 470 further comprises a third annular surface 496 that extends radially outward from the first outer annular edge 482 to a third outer annular edge 498. The third annular surface 496 extends circumferentially around the longitudinal axis 210 and pitches downward away from the longitudinal axis 210. A first outer wall 500 extends longitudinally from the third annular surface 496 to fourth outer annular edge 502. The first outer wall 500 extends circumferentially around and generally parallel to the longitudinal axis 210. The first outer wall 500 is the radial outermost portion of the attachment component 470. As depicted in FIG. 5, attachment component 470 has a diameter 504 measured between opposing first outer walls 500 and through the longitudinal axis 210. The diameter 504 is generally complementary to the diameter 465 of the opening 462. Furthermore, the diameter 504 is slightly greater than inner width 234 of the inlet 226. A fourth annular surface 505 extends radially inward from the fourth outer annular edge 502. The fourth annular surface 505 extends circumferentially around and generally perpendicular to the longitudinal axis 210

With continued reference to FIG. 5, attachment component 470 further comprises an outer surface 506. The outer surface 506 extends circumferentially around and generally parallel to the longitudinal axis 210. The outer surface 506 includes an attachment surface 508 for coupling the filtration component 472 to the attachment component 470. The attachment surface 508 extends longitudinally from a first corner 510 of the outer surface 506 to a second corner 512 of the outer surface 506. The attachment surface 508 has a diameter 514 measured between opposing sides of the attachment surface 508 and through the longitudinal axis 210.

In one particular embodiment, an attachment component 470 is formed from a uniform, monolithic member formed from a non-rigid material. Attachment component 470 may be fabricated from a polymer material; however other materials are entirely contemplated. Furthermore, the integral structure of attachment component 470 may be formed from multiple elements having similar configurations as one having ordinary skill in the art would understand.

As described herein, in embodiments, inlet 226 may be adapted to slidably receive the attachment component 470. Since the attachment component 470 has a diameter 504 that is greater than inner width 234 of the inlet 226 and since the attachment component 470 is formed from a non-rigid material whereas the housing component 201 is formed of a rigid material, the first rounded wall 230 and the second rounded 232 wall compress the attachment component 470 when the attachment component 470 is inserted into the inlet 226. As force is applied to the attachment component 470, the rounded walls continue to compress the attachment component 470 until the attachment component 470 completely passes through inlet 226 and rests within the opening 462. When completely within the opening 462, the attachment component 470 decompresses and returns to its original shape.

When attachment component 470 is inserted into housing component 201, the first outer wall 500 of attachment component 470 contacts the second inner wall 466, the first rounded wall 230 and the second rounded wall 232 of housing component 201 (also shown in FIG. 11). This contact holds attachment component 470 horizontally within housing component 201. Furthermore, the first annular surface 478 of the attachment component 470 contacts the first radially inward extending bosses 464 and the fourth annular surface 505 contacts the second radially inward extending bosses 468 of housing component 201. This contact holds the attachment component vertically within housing component 201. It is to be appreciated that this description applies to other embodiments, for example, housing component 701.

Returning to FIG. 3, the filtration component 472 includes a first end 516, a second end 518, and the longitudinal axis 210 extends between the first end 516 and the second end 518. The second end 518 of the filtration component 472 defines the second end 208 of the silt and debris catching apparatus 100.

The filtration component 472 comprises an annular attachment section 520 and a filtration section 522. In one embodiment, the filtration section 522 is a mesh direct pass-through filter however which selectively retains certain material (i.e., solid material, silt, debris, etc.) while allowing other material (i.e., liquid material, water, etic.) to pass through. In embodiments, other filters including solid filters or other pass-through filters of different lengths, micron sizes, and materials (i.e., plastic fiber, metal, etc.) are contemplated. In particular, a multi-layer debris retainer that may not be flexible is contemplated for use cases such as street repaving, as asphalt debris may be heavier than other debris. The attachment section 520 comprises an annular surface 524. The annular surface 524 extends circumferentially and generally perpendicular to the longitudinal axis 210 and defines an opening 526. The annular surface 524 defines the first end 516. The opening 526 has a diameter 528 measured between opposing sides of the annular surface 524 though the longitudinal axis 210. The diameter 528 is generally complementary the diameter 514 of the attachment surface 508. The attachment section 520 may be coupled to the attachment surface 508. In one embodiment, attachment section 520 is coupled to attachment surface 508 via several crimps. Other forms of coupling (i.e., chemical adhesives, stitching, etc.) are envisioned. When the filtration component 472 is coupled to the attachment component 470, the opening 526 is in open communication with the second opening 491 of the attachment component 470.

FIG. 3, FIG. 3A and FIG. 5 depict an embodiment of a valve box assembly 102 in operation with an embodiment of the silt and debris catching apparatus 100. It is to be appreciated that valve box assembly 102 may take several forms as known in the art, for example, and without limitation, valve box assemblies 602 and 702. Embodiments of valve box assembly 702 are shown in FIG. 7 through FIG. 13.

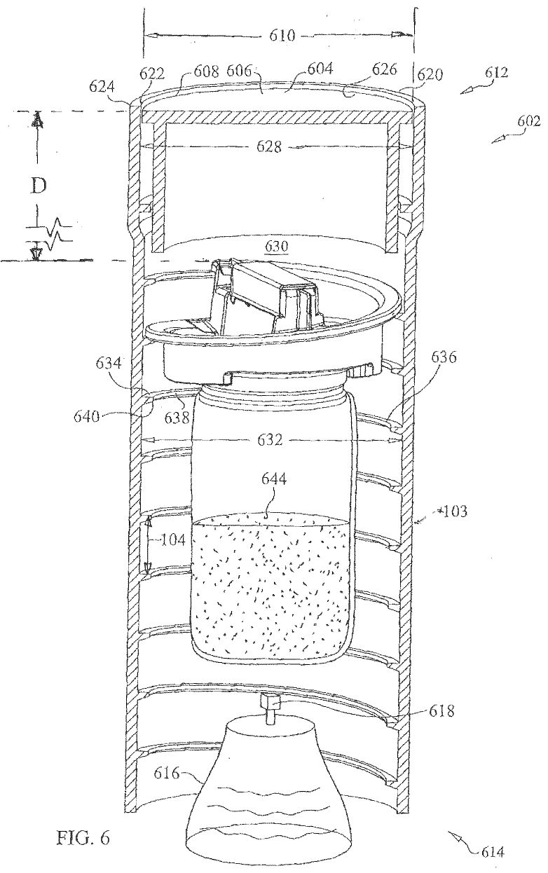

Turning to FIG. 6, a longitudinal partial cross-section perspective view of the operational embodiment is described in relation to an embodiment of the valve box assembly 602 and may include a valve body riser 103 and a valve box cover 604. It is to be appreciated that in other embodiments, for example as depicted in FIG. 7A and FIG. 13, other embodiments of valve box assemblies may include a plurality of valve body risers (for example valve body riser 103 and lower riser 703) and a valve box cover 604. It is to be appreciated that while the embodiments discussed may use terminology of valve box assemblies 102, 602, or 702, other valve box assemblies not shown are applicable to the disclosed innovative concepts.

Returning to FIG. 6, a circular surface 606 of valve box cover 604 is defined by an outer edge 608 of valve box cover 604. Circular surface 606 extends circumferentially around and is generally perpendicular to the longitudinal axis 210. Circular surface 606 has a diameter 610 measured between opposing outer edges 608 and through the longitudinal axis 210. Valve box assembly 602 includes a first end 612 and a second end 614 opposite first end 612. The longitudinal axis 210 is between first end 612 and second end 614. It is to be appreciated that when valve box assembly 602 is placed in the ground, first end 612 is generally flush with the ground surface. Second end 614 may be adjacent to a pipe 616. It is to be appreciated that typically a valve box assembly, such as 602 will be concentric with a control valve 618 that is coupled to the pipe 616. As pictured in FIG. 6, a first annular surface 620 defines the first end 612. First annular surface 620 may be defined by a first inner annular edge 622 and a first outer annular edge 624. The first annular surface 620 extends circumferentially around and generally perpendicular to the longitudinal axis 210. The first inner annular edge 622 defines a first opening 626. The first opening 626 has a diameter 628 measured through the longitudinal axis 210 and between opposing first inner annular edges 622. The diameter 628 of the first opening 626 is generally complementary to the diameter 610 of the valve box cover 604, with diameter 610 generally less than diameter 628 but greater than an inner diameter 632, as discussed below. The complementary diameters 610 and 628 of the valve box cover 604 and the valve body riser 103 permit the valve box cover 604 to loosely fit into the valve body riser 103. The loose fit permits the valve box cover 604 to be placed into and removed from the valve body riser 103 by hand. Furthermore, diameter 628 is slightly larger than diameter 214 of housing component 201 which allows the slit and debris catching apparatus 100 to be placed within the valve box assembly 102.

The valve body riser 103 further comprises an inner surface 630. The inner surface 630 extends circumferentially around and generally parallel to the longitudinal axis 210. The inner surface 630 has a diameter 632 measured between opposing sides of the inner surface 630. The diameter 632 of the inner surface 630 is slightly less than the diameter 628 of the valve body riser 103. Furthermore, the diameter 632 is generally complementary to the diameter 214 of the housing component 201. An upper surface 634 of the thread 106 extends radially inward from the inner surface 630 to a first edge 636. A crest 638 of the thread 106 extends longitudinally from the first edge 636 to a second edge 640. Crest 638 extends circumferentially and generally parallel to the longitudinal axis 210 and the upper surface 634 extends circumferentially and generally perpendicular to the longitudinal axis 210.

Since the diameter 632 of the inner surface 630 is generally complementary to the diameter 214 of the housing component 201 and since the upper surface 634 of the thread 106 extends radially inward from the inner surface 630, when the silt and debris catching apparatus 100 is placed within the valve box assembly 102, the rounded surface 236 of the housing component 201 rests upon the upper surface 634 of the thread 106. Furthermore, since the pitch 104 of the thread 106 corresponds to the pitch 316 of the helix surface 306, the silt and debris catching apparatus 100 may be lowered into the valve box assembly 102 by rotating the silt and debris catching apparatus 100 clockwise about the longitudinal axis 210 and may be removed from the valve box assembly 102 by rotating the silt and debris catching apparatus 100 counterclockwise about the longitudinal axis 210. In embodiments, the silt and debris catching apparatus 100 may be lowered approximately 3-5 feet below the surface within valve box assembly 102 (see D on FIG. 6). It is to be appreciated that such provides advantages that may not be possible with straining devices that are located near a surface in which temperature concerns may arise. In embodiments, when a surface temperature is below freezing, it is to be appreciated that subsurface temperatures may exceed freezing. Generally, this may be at a range of 3-5 feet, and it is to be appreciated that other ranges may apply. As a result, water that enters catchment component 204 may not freeze which allows water to pass through the catchment component 204. It is to be further appreciated that in certain circumstances, such as variances within a season (for example thaw and freeze cycles), screening applications that are not below a freeze line can have their performance adversely affected, removing the advantages of the present disclosure.

In embodiments, first opening 626 of the valve box assembly 102 may be in open communication with the opening 462 of the housing component 201. As such material 644 (i.e., water, silt, debris, etc.) may enter the first opening 626 of the valve box assembly 102 and pass through the opening 462 of the housing component 201. Since the opening 462 of the housing component 201 is in open communication with the opening 526 of the filtration component 472, the material 644 that passes through the opening 462 of the housing component 201 may enter the filtration section 522 and allowing water to continue flowing, capturing material 644 that otherwise would clog access to control valve 618. After the silt and debris catching apparatus 100 is removed from the valve box assembly 102, the catchment component 204 may be removed from the housing component 201. When removed, catchment component 204 may be inverted thereby removing material 644 from filtration component 472. It is to be appreciated that similar mechanism would occur with an embodiment of silt and debris catching apparatus 700 and the embodiment of valve box assembly 702 as discussed herein.

Turning now to FIG. 7A and FIG. 13, another embodiment of a silt and debris catching apparatus 700 is shown with an embodiment of a valve box assembly 702 as discussed herein. FIG. 8 through FIG. 10 provide views of details of an embodiment of housing component 701. FIG. 11 through FIG. 13 provide views of an embodiment with varying degrees of assembly of a silt and debris catching apparatus in a valve box assembly.

FIG. 7A is an assembled operational partial cutaway perspective view depicting an embodiment of a valve box assembly 702 with a silt and debris catching apparatus 700. Valve box assembly 702 may have a valve body riser 103 (alternatively known as a first valve body riser), a lower riser 703 (alternatively known as a second valve body riser) and a valve box cover 604. It is to be appreciated that references may be made to FIG. 6 for some descriptions of valve body riser 103.

Valve box assembly 702 includes a first end 705 and a second end 707 opposite first end 705. Longitudinal axis 710 continues between first end 705 and second end 707. With brief reference to FIG. 6 (for valve body riser 103), a first annular surface 620 defines the first end 705. First annular surface 620 may be defined by a first inner annular edge 622 and a first outer annular edge 624. It is to be appreciated that longitudinal axis 710 may be referred to as longitudinal axis 210, as some descriptions of embodiments are interchangeable. It is to be further appreciated that when valve box assembly 702 is placed in the ground, first end 705 is generally flush with the ground surface. Second end 707 may be adjacent to pipe 616. In embodiments, second end 707 may define a lower portion of lower riser 703. It is to be appreciated that typically a valve box assembly, such as 702, will be concentric with a control valve 618 that is coupled to pipe 616.

The first annular surface 620 extends circumferentially around and generally perpendicular to longitudinal axis 710. The first inner annular edge 622 defines a first opening 626. First opening 626 has a diameter 628 measured through longitudinal axis 710 and between opposing first inner annular edges 622. A circular surface 606 of valve box cover 604 is defined by an outer edge 608 of valve box cover 604. Circular surface 606 extends circumferentially around and is generally perpendicular to longitudinal axis 710. Circular surface 606 has a diameter 610 measured between opposing outer edges 608 and through the longitudinal axis 710. Diameter 628 of first opening 626 is generally complementary to the diameter 606 of the valve box cover 604, with diameter 606 generally less than diameter 628 but greater than an inner diameter 632, as noted herein. The complementary diameters 606 and 628 of the valve box cover 604 and the valve body riser 103 permit the valve box cover 604 to loosely fit into the valve body riser 103. The loose fit permits the valve box cover 604 to be placed into and removed from the valve body riser 103 by hand. Furthermore, the diameter 628 is slightly larger than the diameter 714 of the housing component 701 which allows the slit and debris catching apparatus 700 to be placed within the valve box assembly 702.

The valve body riser 103 further comprises an inner surface 630. The inner surface 630 extends circumferentially around and generally parallel to the longitudinal axis 210. The inner surface 630 has a diameter 632 measured between opposing sides of the inner surface 630. The diameter 632 of the inner surface 630 is slightly less than the diameter 628 of the valve body riser 103. Furthermore, diameter 632 is generally complementary to a diameter 732 (not shown) of the lower riser 703. An upper surface 634 of the thread 106 extends radially inward from the inner surface 630 to a first edge 636. A crest 638 of thread 106 extends longitudinally from the first edge 636 to a second edge 640. Crest 638 extends circumferentially and generally parallel to the longitudinal axis 710 and the upper surface 634 extends circumferentially and generally perpendicular to the longitudinal axis 710.

As pictured in FIG. 7B, lower riser 703 has a first annular surface 720. First annular surface 720 may be defined by a first inner annular edge 722 and a first outer annular edge 724. The first annular surface 720 extends circumferentially around and generally perpendicular to longitudinal axis 710. First inner annular edge 722 defines a second opening 726 (not shown). Lower riser 703 further comprises an inner surface 730. Inner surface 730 extends circumferentially around and generally parallel to the longitudinal axis 710. The second opening 726 has a diameter 732 (not shown) measured through the longitudinal axis 710 and between opposing first inner annular edges 722. The diameter 732 of the second opening 726 is generally complementary to and slightly greater than diameter 714 of a housing component 701. The complementary diameters 714 and 732 of housing component 701 and lower riser 703 permit housing component 701 to loosely fit into the lower riser 703. The loose fit permits housing component 701 to be placed into and removed from the lower riser 703 by hand. Furthermore, diameter 714 of housing component 701 is slightly larger than diameter 726 but smaller than diameter 732 which allows the slit and debris catching apparatus 700 to be placed within the valve box assembly 702, pass through valve body riser 103 and set on first annular surface 720 of lower riser 703, as shown in FIG. 7B.

The lower riser 703 further comprises an outer surface 728. The outer surface 728 extends circumferentially around and generally parallel to the longitudinal axis 710. The outer surface 728 has a diameter 726 (not shown) measured between opposing sides of the outer surface 728. The diameter 726 of the outer surface 728 is slightly less than the diameter 628 of the valve body riser 103. Furthermore, the diameter 732 is generally complementary to a diameter 628 of the valve body riser 103. Outer surface 728 is configured to have a thread 706 extends radially outward with a crest 738. Crest 738 extends circumferentially and generally parallel to longitudinal axis 710. Thread 706 may extend for one or more revolutions around longitudinal axis 710.

In constructing a valve box assembly with valve body riser 103 and lower riser 703, valve body riser 103 is typically adjusted after installation of lower riser 703 to reach a local surface (and miles of piping systems may present many multiple different heights of local surface). Since the diameter 632 of the inner surface 630 is generally complementary to the diameter 732 of the lower riser 703 and since thread 106 extends radially inward from the inner surface 630, when valve body riser 103 is placed within the valve box assembly 702, thread 106 of valve body riser 103 rests upon thread 706 of lower riser 703. Furthermore, since the pitch 104 of the thread 106 corresponds to the pitch 704 of lower riser 703, valve body riser 103 may be adjusted downward into the valve box assembly 702 by rotating valve body riser 103 clockwise about the longitudinal axis 710 or and may be adjusted upward in relation to the valve box assembly 702 by rotating valve body riser 103 counterclockwise about the longitudinal axis 710.

It is to be appreciated that through most adjustments, first annular surface 720 of lower riser 703 may be located approximately 3-5 feet below the surface within valve box assembly 702. It is to be further appreciated that such provides advantages that may not be possible with straining devices that are located near a surface in which temperature concerns may arise. In embodiments, when a surface temperature is below freezing, it is to be appreciated that subsurface temperatures may exceed freezing. Generally, this may be at a range of 3-5 feet, and it is to be appreciated that other ranges may apply. As a result, water that enters catchment component 204 may not freeze which allows water to pass through the catchment component 204. It is to be further appreciated that in certain circumstances, such as variances within a season (for example thaw and freeze cycles), screening applications that are not below a freeze line can have their performance adversely affected, removing the advantages of the present disclosure.

Placing an apparatus, such as for example apparatus 700, into valve box assembly 702 is simplified per the disclosed innovation. One may remove a valve box cover 604, and in some embodiments, determine a length of field installable second handle 796. Field installable second handle 796 is field installable and adjustable, as a desired height is likely to vary for many valve box assemblies in a piping network. Attach the field installable second handle 796 to apparatus 700 by way of slots 794 in housing component 701. It is to be appreciated that housing component 701 is configured to pass through first valve body riser 103 and rest on annular surface 720 of second valve body riser 703 (the portion of second valve body riser facing first end 705), and that housing component 701 has a first handle 320. The configuration as disclosed provides that apparatus 700 will self-align as it passes down through first valve body riser 103 with housing component 701 being guided by thread 106 of first valve body riser 103, allowing apparatus 700 to come to rest on annular surface 720.

In embodiments, first opening 626 of the valve box assembly 702 may be in open communication with the opening 762 of the housing component 701. As such material 644 (i.e., water, silt, debris, etc.) may enter the first opening 626 of the valve box assembly 702 and pass through the opening 762 of the housing component 701. Since the opening 762 of the housing component 701 is in open communication with the opening 526 of the filtration component 472, the material 644 that passes through the opening 762 of the housing component 701 may enter the filtration section 522 and allowing water to continue flowing and capturing material 644 that otherwise would clog access to control valve 618. After the silt and debris catching apparatus 700 is removed from the valve box assembly 702, the catchment component 204 may be removed from the housing component 701. When removed, catchment component 204 may be inverted thereby removing material 644 from filtration component 472.

Various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

As disclosed herein, apparatus 700 is provided for maintaining valve accessibility in a valve box assembly 702. Apparatus 700 comprises a housing component 701 configured to pass through a first valve body riser 103 and rest on annular portion (or surface) 720 of second valve body riser 703 of valve box assembly 702. It is to be appreciated that apparatus 700 further comprises catchment component 204 that comprises a top portion and a mesh portion as disclosed herein. It is to be further appreciated that the mesh portion is adapted to retain material 644 that enters valve box assembly 702. Still further to be appreciated, the top portion of catchment component 204 is adapted to attach to housing component 701 as disclosed in that housing component 701 is configured to slidably receive the top portion of catchment component 204.

Embodiments also provide housing component 701 that may be configured with first handle 320 defining a pair of slots 794 spaced apart from one another. It is to be appreciated that apparatus 700 self-aligns as apparatus 700 passes through first valve body riser 103. Upon being installed, housing component 701 is guided by thread 106 (also referred to as a set of threads) of first valve body riser 103 as housing component 701 passes through first valve body riser 103 to rest on annular portion (or surface) 720 of second valve body riser 703 of the valve box assembly 702.

Also as disclosed herein, embodiments of the disclosed innovation also include a method for configuring an apparatus 700 for maintaining valve accessibility in valve box assembly 702. The method includes locating valve box assembly 702 that has a first valve body riser 103, a second valve body riser 703 and a valve box cover 604. After removing valve box cover 604, the method may include placing a top portion of catchment component 204 into a slidably receiving portion ((for example, 220, 224, 226, 228, 230, 232, 234, and the like)) of housing component 701 that is configured to provide a path through rigid members (for example 230, 232). The method includes dropping apparatus 701 into valve box assembly 702, and reengaging valve box cover 604 with first valve body riser 103.

It is to be appreciated that method embodiments include a housing component (such as for example housing component 701) that is configured with first handle 320 defining a pair of slots 794 spaced apart from one another, along with a catchment component (for example, catchment component 204) that is configured to self-align as apparatus 701 passes through first valve body riser 103. Other embodiments may include that during the dropping, housing component 701 may be guided by thread 106 (also referred to as a set of threads) of first valve body riser 103 as housing component 701 passes through first valve body riser 103 to rest on annular portion (or surface) 720 of second valve body riser 703 of the valve box assembly 702.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

To the extent that the present disclosure has utilized the term “invention” in various titles or sections of this specification, or in the context of those sections, this term has been included as required by the formatting requirements of word document submissions (i.e., docx submissions) pursuant the guidelines/requirements of the United States Patent and Trademark Office and shall not, in any manner, be considered a disavowal of any subject matter.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clarity, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. An apparatus for maintaining valve accessibility in a valve box assembly comprising:
a housing component configured to pass through a first valve body riser and rest on an annular portion of a second valve body riser of the valve box assembly;
a catchment component comprising a top portion and a mesh portion, wherein the catchment component is adapted to, in the mesh portion, retain material that enters the valve box assembly, wherein the catchment component is adapted to, in the top portion, attach to the housing component; and
wherein the adapted to attach comprises the housing component configured to slidably receive the top portion of the catchment component.

2. The apparatus of claim 1, wherein:
the housing component is configured with a first handle defining a pair of slots spaced apart from one another; and
the apparatus self-aligns as the apparatus passes through the first valve body riser.

3. The apparatus of claim 2, further wherein upon being installed, the housing component is guided by a set of threads of the first valve body riser as the housing component passes through the first valve body riser to rest on the annular portion of the second valve body riser of the valve box assembly.

4. The apparatus of claim 3, wherein the housing component further comprises an outer wall with a diameter less than an inner diameter of the set of threads of the first valve body riser and greater than an inner diameter of the second valve body riser.

5. The apparatus of claim 3, wherein the housing component rests below a freeze line of the valve box assembly upon being installed in the valve box assembly.

6. The apparatus of claim 2, further comprising:
a field-installable adjustable second handle configured to attach to the housing component through the pair of slots.

7. The apparatus of claim 6, wherein the field-installable adjustable second handle of the housing component comprises a portion that rests at or is positioned near a valve box cover of the valve box assembly upon being installed in the valve box assembly.

8. The apparatus of claim 2, wherein the first handle is integrally formed from a single piece of rigid polymer with a body of the housing component.

9. The apparatus of claim 1, wherein the housing component configured to slidably receive the top portion is by way of a path through rigid members defining a passage narrower than a diameter of the top portion.

10. The apparatus of claim 9, wherein the top portion is configured to be flexible and compresses while passing through the rigid members and rebounds to a prior size of the top portion after passing through.

11. A method for configuring an apparatus for maintaining valve accessibility in a valve box assembly comprising:
locating a valve box assembly that comprises a first valve body riser, a second valve body riser and a valve box cover;
removing the valve box cover from the first valve body riser;
placing a top portion of a catchment component of an apparatus into a slidably receiving portion of a housing component that is configured to provide a path through rigid members;
dropping the apparatus into the valve box assembly; and
reengaging the valve box cover with the first valve body riser.

12. The method of claim 11, wherein:
the housing component is configured with a first handle defining a pair of slots spaced apart from one another; and
the catchment component is configured to self-align as the apparatus passes through the first valve body riser.

13. The method of claim 12, further wherein during the dropping, the housing component is guided by a set of threads of the first valve body riser as the housing component passes through the first valve body riser to rest on an annular portion of the second valve body riser of the valve box assembly.

14. The method of claim 13, wherein a depth of the housing component resting on the annular portion is below a freeze line for the valve box assembly.

15. The method of claim 14, further comprising:
attaching a field installable adjustable second handle to the housing component through the pair of slots prior to dropping the apparatus into the valve box assembly.

16. The method of claim 15 wherein the step of attaching the field installable adjustable second handle further comprises:
inserting a desired amount of the field installable adjustable second handle into the pair of slots of the housing component to obtain a second depth of a top loop of the field installable second handle at or near a valve box cover of the valve box assembly with the housing component resting on the annular portion.

17. The method of claim 12, wherein the slidably receiving portion of the housing component is formed of a one-piece construction with the first handle of the housing component.

18. The method of claim 11, wherein the top portion of the catchment component is configured to be flexible and compresses while passing through the rigid members and rebounds to a prior size of the flexible top portion after passing through.

19. The method of claim 11, wherein the housing component further comprises:
at least one selected off-center inner diameter, with a centerline parallel to a centerline of the housing component, that defines a bore operable to support a tracer wire passing through the housing component.

20. A system for maintaining valve accessibility in a valve box assembly comprising:
a valve box assembly that comprises a first valve body riser, a second valve body riser and a valve box cover;
a housing component of an apparatus configured to pass through the first valve body riser and rest on an annular portion of the second valve body riser;
a catchment component comprising a top portion and a mesh portion, wherein the catchment component is adapted to, in the mesh portion, retain material that enters the valve box assembly, wherein the catchment component is adapted to, in the top portion, attach to the housing component; and
wherein the adapted to attach comprises the housing component configured to slidably receive the top portion of the catchment component.

21. The system of claim 20, wherein the apparatus self-aligns as the apparatus passes through the first valve body riser.

22. The system of claim 21, further wherein upon being installed, the housing component is guided by a set of threads of the first valve body riser as the housing component passes through the first valve body riser to rest on the annular portion of the second valve body riser of the valve box assembly.

23. The system of claim 22, further wherein the housing component rests below a freeze line of the valve box assembly.

24. The system of claim 20, wherein:
the housing component is configured with a first handle defining a pair of slots spaced apart from one another; and
wherein a slidably receiving portion of the housing component defines a path through rigid members to slidably receive the top portion of the catchment component and the top portion of the catchment component is configured to be flexible and compresses while passing through the rigid members and rebounds to a prior size of the flexible top portion after passing through.

25. The system of claim 24, further comprising:
a field-installable adjustable second handle configured to attach to the pair of slots of the housing component, the field-installable adjustable second handle of the housing component comprises a portion that rests at or is positioned near the valve box cover of the valve box assembly.
